(19) United States
(12) Patent Application Publication
(10) Pub. No.: US 2020/0165283 A1
(43) Pub. Date: May 28, 2020

(54) PROCESS

(71) Applicant: JOHNSON MATTHEY PUBLIC LIMITED COMPANY, London (GB)

(72) Inventors: Hans Guenter NEDDEN, Cambridge (GB); Vaclav JURCIK, Cambridge (GB); Garazi TALAVERA, Cambridge (GB)

(21) Appl. No.: 16/628,455

(22) PCT Filed: Jul. 4, 2018
(86) PCT No.: PCT/GB2018/051886

§ 371 Date: Jan. 3, 2020

(30) Foreign Application Priority Data
Jul. 7, 2017 (GB) 1710954.7
May 2, 2018 (GB) 1807243.9

(51) Int. Cl. C07F 17/02; C07B 53/00

(52) U.S. Cl. CPC C07F 17/02; C07B 53/00

(57) ABSTRACT

The present invention provides a metallocenyl compound of formula (I). R^{a}, R^{b}, R^{c}, R^{d}, R^{e}, R^{f}, M, m, n, j, k, Y and Z and * are as described in the specification. The invention also provides a process for the preparation of the complexes, a process for increasing the optical purity of a compound of formula (II) and a process for the asymmetric transfer hydrogenation (ATH) of a metallocenyl compound of formula (V) to a metallocenyl compound of formula (IV).

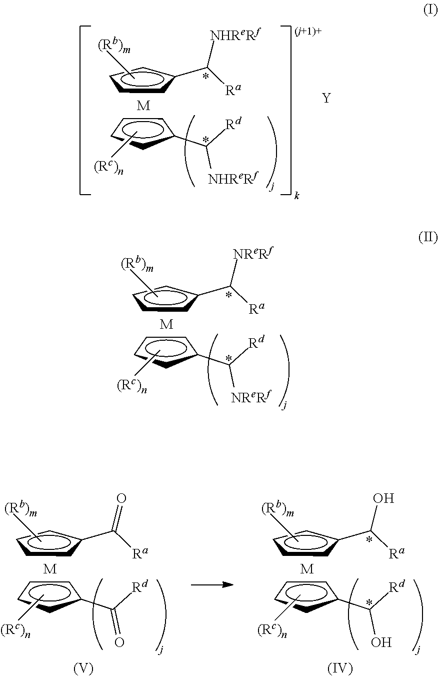

The present invention relates to quaternary ammonium salts of metallocenyl-containing amines and a process for the preparation thereof. In particular, the invention relates to optically active quaternary ammonium salts of metallocenyl-containing amines, wherein the anion is non optically active. The present invention also relates to an improved process for the preparation of a metallocenyl alcohol. In particular, the invention relates to the preparation of optically active metallocenyl alcohols by asymmetric transfer hydrogenation (ATH).

Enantioenriched N,N-dimethyl-α-ferrocenylethylamine (Ugi amine) is a versatile starting material for the synthesis of various chiral ligands used in asymmetric catalysis. U.S. Pat. No. 5,760,264 (to Lonza) describes the synthesis of enantioenriched N,N-dimethyl-α-ferrocenylethylamine (B) by a multi-step procedure (Scheme 1), starting from acetylferrocene, which is reduced in the presence of a chiral borane to obtain (R)-(1-hydroxyethyl)ferrocene (D), followed by acetylation, to obtain (R)-(1-acetoxyethyl)ferrocene (C) in 88% ee. This product is subsequently treated with dimethylamine to obtain (R)-[1-dimethylamino)ethyl]ferrocene (N,N-dimethyl-α-ferrocenylethylamine, Ugi amine, B). Presuming that the amination step is carried out without erosion of optical purity, the maximum ee of the product is 88%.

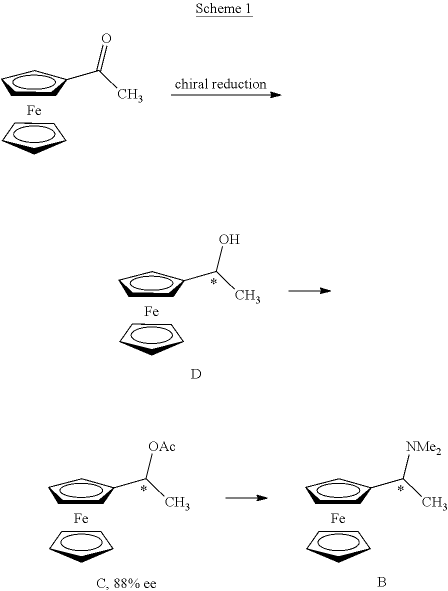

N,N-dimethyl-α-ferrocenylethylamine (B) was obtained optically pure by resolution with a chiral anion. In one example by Gokel et al (J. Chem. Ed., 1972, 49, 294), racemic N,N-dimethyl-α-ferrocenylethylamine was treated with R-(+)-tartaric acid. However, the described salt resolution can yield a single desired enantiomer in a theoretical yield of 50%.

In addition to their use in obtaining optically active metallocenyl-containing amines, optically active metallocenyl alcohols are useful as intermediates in the preparation of bis-phosphorus-containing metallocenyl ligands, such as Bophoz, Josiphos and Xyliphos ligands.

### SUMMARY OF THE INVENTION

The present invention provides quaternary ammonium salts of metallocenyl-containing amines in high purity and/or high enantiomeric excess, which are obtained in high yields. In certain embodiments the quaternary ammonium salts of metallocenyl-containing amines have high chemical purity. In certain embodiments the quaternary ammonium salts of metallocenyl-containing amines have high enantiomeric excess.

The present invention is also more suited to the large-scale manufacture of optically active metallocenyl alcohols. In certain embodiments, the ATH process produces the optically active metallocenyl alcohol in high yields. In certain embodiments, the ATH process produces the optically active metallocenyl alcohol in high enantiomeric excess.

Accordingly, the invention provides a metallocenyl compound of formula (I),

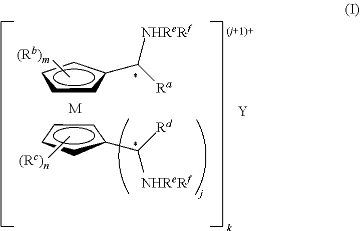

wherein:
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} or Z^{(j+1)k-};
Z is a non optically active anion; and
* denotes an optically active carbon atom.

In another aspect, the invention provides a process for the preparation of a metallocenyl compound of formula (I)

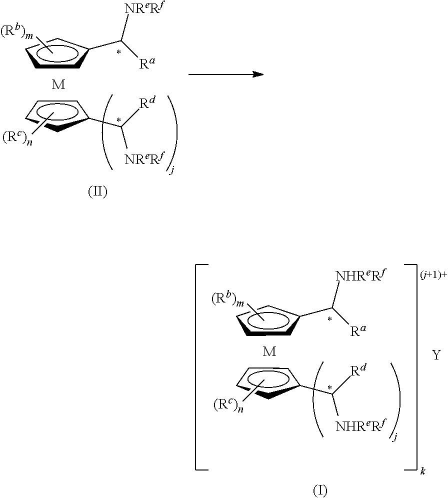

comprising mixing a compound of formula (II) with an acid Hₖ₍ⱼ₊₁₎Z in a solvent to form a compound of formula (I),
wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} or Z^{(j+1)k-};
Z is a non optically active anion; and
* denotes an optically active carbon atom.

In yet another aspect, it is provided a process for increasing the optical purity of a compound of formula (II),

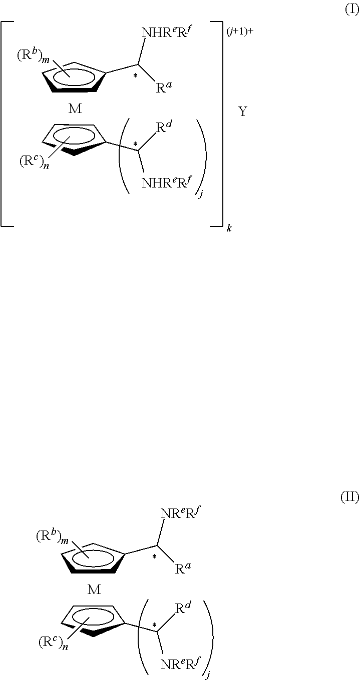

comprising the steps of:
a) mixing a metallocenyl compound of formula (I) with a solvent to obtain a suspension of solid particles in a liquid, wherein the mixing is carried out at about the boiling point of the solvent;
b) separating metallocenyl compound of formula (I) as a solid from the suspension of step a).
c) obtaining the compound of formula (II) from the metallocenyl compound of formula (I) of step b) in the presence of a base,
wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} or Z^{(j+1)k-};
Z is a non optically active anion; and
* denotes an optically active carbon atom.

In another aspect, the invention provides a process for the asymmetric transfer hydrogenation (ATH) of a metallocenyl compound of formula (V) to a metallocenyl compound of formula (IV),

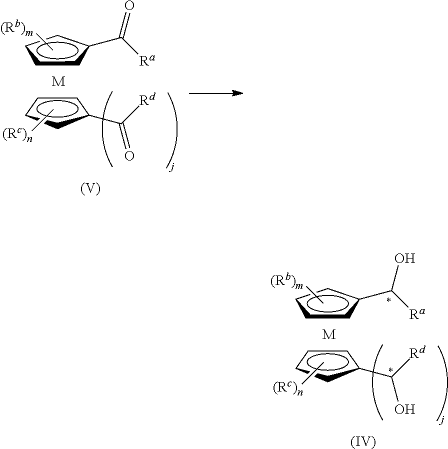

wherein:
the asymmetric transfer hydrogenation is carried out in an aqueous solvent at a temperature greater than 60° C. in the presence of an asymmetric transfer hydrogenation catalyst and activated formic acid; wherein:
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5;
when j=1, n is an integer from 0 to 4; and
* denotes an optically active carbon atom.

### Definitions

The point of attachment of a moiety or substituent is represented by “-”. For example, —OH is attached through the oxygen atom.

“Activated formic acid” refers to a mixture of formic acid, a tertiary amine base and optionally water which forms a liquid reducing agent for an ATH reaction.

“Alkyl” refers to a straight-chain or branched saturated hydrocarbon group. In certain embodiments, the alkyl group may have from 1-20 carbon atoms, in certain embodiments from 1-15 carbon atoms, in certain embodiments, 1-8 carbon atoms. The alkyl group may be unsubstituted. Alternatively, the alkyl group may be substituted. Unless otherwise specified, the alkyl group may be attached at any suitable carbon atom and, if substituted, may be substituted at any suitable atom. Typical alkyl groups include but are not limited to methyl, ethyl, n-propyl, iso-propyl, n-butyl, iso-butyl, sec-butyl, tert-butyl, n-pentyl, n-hexyl and the like.

The term “cycloalkyl” is used to denote a saturated carbocyclic hydrocarbon group. In certain embodiments, the cycloalkyl group may have from 3-15 carbon atoms, in certain embodiments, from 3-10 carbon atoms, in certain embodiments, from 3-8 carbon atoms. The cycloalkyl group may be unsubstituted. Alternatively, the cycloalkyl group may be substituted. Unless otherwise specified, the cycloalkyl group may be attached at any suitable carbon atom and, if substituted, may be substituted at any suitable atom. Typical cycloalkyl groups include but are not limited to cyclopropyl, cyclobutyl, cyclopentyl, cyclohexyl and the like.

“Alkoxy” refers to an optionally substituted group of the formula alkyl-O— or cycloalkyl-O—, wherein alkyl and cycloalkyl are as defined above.

“Aryl” refers to an aromatic carbocyclic group. The aryl group may have a single ring or multiple condensed rings. In certain embodiments, the aryl group can have from 5-20 carbon atoms, in certain embodiments from 6-15 carbon atoms, in certain embodiments, 6-12 carbon atoms. The aryl group may be unsubstituted. Alternatively, the aryl group may be substituted. Unless otherwise specified, the aryl group may be attached at any suitable carbon atom and, if substituted, may be substituted at any suitable atom. Examples of aryl groups include, but are not limited to, phenyl, naphthyl, anthracenyl and the like.

“Arylalkyl” refers to an optionally substituted group of the formula aryl-alkyl-, where aryl and alkyl are as defined above.

“Aryloxy” refers to an optionally substituted group of the formula aryl-O—, where aryl is as defined above.

“Halo”, “hal” or “halide” refers to —F, —Cl, —Br and —I.

“Heteroalkyl” refers to a straight-chain or branched saturated hydrocarbon group wherein one or more carbon atoms are independently replaced with one or more heteroatoms (e.g. nitrogen, oxygen, phosphorus and/or sulfur atoms). In certain embodiments, the heteroalkyl group may have from 1-20 carbon atoms, in certain embodiments from 1-15 carbon atoms, in certain embodiments, 1-8 carbon atoms. The heteroalkyl group may be unsubstituted. Alternatively, the heteroalkyl group may substituted. Unless otherwise specified, the heteroalkyl group may be attached at any suitable atom and, if substituted, may be substituted at any suitable atom. Examples of heteroalkyl groups include but are not limited to ethers, thioethers, primary amines, secondary amines, tertiary amines and the like.

“Heterocycloalkyl” refers to a saturated cyclic hydrocarbon group wherein one or more carbon atoms are independently replaced with one or more heteroatoms (e.g. nitrogen, oxygen, phosphorus and/or sulfur atoms). In certain embodiments, the heterocycloalkyl group may have from 2-15 carbon atoms, in certain embodiments from 2-10 carbon atoms, in certain embodiments, 2-8 carbon atoms. The heterocycloalkyl group may be unsubstituted. Alternatively, the heterocycloalkyl group may be substituted. Unless otherwise specified, the heterocycloalkyl group may be attached at any suitable atom and, if substituted, may be substituted at any suitable atom. Examples of heterocycloalkyl groups include but are not limited to epoxide, morpholinyl, piperadinyl, piperazinyl, thirranyl, pyrrolidinyl, pyrazolidinyl, imidazolidinyl, thiazolidinyl, thiomorpholinyl and the like.

“Heteroaryl” refers to an aromatic carbocyclic group wherein one or more carbon atoms are independently replaced with one or more heteroatoms (e.g. nitrogen, oxygen, phosphorus and/or sulfur atoms). In certain embodiments, the heteroaryl group may have from 4-20 carbon atoms, in certain embodiments from 4-15 carbon atoms, in certain embodiments, 4-8 carbon atoms. The heteroaryl group may be unsubstituted. Alternatively, the heteroaryl group may be substituted. Unless otherwise specified, the heteroaryl group may be attached at any suitable atom and, if substituted, may be substituted at any suitable atom. Examples of heteroaryl groups include but are not limited to thienyl, furanyl, pyrrolyl, imidazolyl, pyrazolyl, thiazolyl, isothiazolyl, oxazolyl, isoxazolyl, triazolyl, thiadiazolyl, thiophenyl, oxadiazolyl, pyridinyl, pyrimidyl, benzoxazolyl, benzthiazolyl, benzimidazolyl, indolyl, quinolinyl and the like.

“Substituted” refers to a group in which one or more hydrogen atoms are each independently replaced with substituents (e.g. 1, 2, 3, 4, 5 or more) which may be the same or different. The group may be substituted with one or more substituents up to the limitations imposed by stability and the rules of valence. The substituents are selected such that they are not adversely affected under the ATH, acylation, amination or salt formation reaction conditions. Examples of substituents include but are not limited to -halo, —CF₃, —R^{a}, —O—R^{m}, —S—R^{m}, —NR^{m}Rⁿ, —CN, —C(O)—R^{m}, —COOR^{m}, —C(S)—R^{m}, —C(S)OR^{m}, —S(O)₂OH, —S(O)₂—R^{m}, —S(O)₂NR^{m}Rⁿ and —CONR^{m}Rⁿ, preferably -halo, —CF₃, —R^{m}, —O—R^{m}, —NR^{m}Rⁿ, —COOR^{m}, —S(O)₂OH, —S(O)₂—R^{m}, —S(O)₂NR^{m}Rⁿ and —CONR^{m}Rⁿ. R^{m} and Rⁿ are independently selected from the groups consisting of H, alkyl, aryl, arylalkyl, heteroalkyl, heteroaryl, or R^{m} and Rⁿ together with the atom to which they are attached form a heterocycloalkyl group, and wherein R^{m} and Rⁿ may be unsubstituted or further substituted as defined herein.

“Metallocenyl” refers to a transition metal complex group wherein a transition metal atom or ion is “sandwiched” between two rings of atoms. The metallocenyl group may be substituted or unsubstituted. Unless otherwise specified, the metallocenyl group may be attached at any suitable atom and, if substituted, may be substituted at any suitable atom. Examples of transition metal atoms or ions include but are not limited to ruthenium, osmium, nickel and iron. An example of a suitable ring of atoms is a cyclopentadienyl ring. An example of a metallocenyl group includes but is not limited to ferrocenyl, which comprises a Fe(II) ion sandwiched between two cyclopentadienyl rings, wherein each cyclopentadienyl ring may be independently unsubstituted or substituted.

“Optically active” means capable of rotating the plane of vibration of polarized light to the right or left.

“Halide anion” refers to F⁻, Cl⁻, Br⁻ and I⁻.

An “oxy-anion” means an anion containing one or more oxygen atoms bonded to another element.

A “monoanion” is an ion having a single negative charge. A “dianion” is an anion carrying two negative charges.

An “acyl group” is a moiety derived by the removal of one or more hydroxyl groups from a carboxylic acid.

A “suspension” is a heterogeneous mixture that contains solid particles sufficiently large for sedimentation on standing.

An “aqueous solvent” refers to water or a mixture of water and water-miscible solvents.

### DETAILED DESCRIPTION

Metallocenyl Compounds of Formula (I) and (II)

In one aspect the invention provides a metallocenyl compound of formula (I),

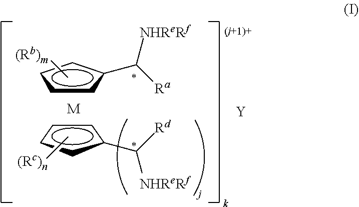

wherein:
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} Or Z^{(j+1)k-};
Z is a non optically active anion; and
* denotes an optically active carbon atom.

R^{a} may be selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen. In one embodiment, R^{a} is selected from the group consisting of unsubstituted C₁-C₂₀-alkyl, unsubstituted C₃-C₁₅-cycloalkyl, unsubstituted C₅-C₂₀-aryl, unsubstituted C₄-C₂₀-heteroaryl, wherein the heteroatoms in the C₄-C₂₀-heteroaryl are selected from the group consisting of sulfur, oxygen and nitrogen. R^{a} may be substituted or unsubstituted branched- or straight-chain alkyl groups such as methyl, ethyl, n-propyl, iso-propyl, n-butyl, iso-butyl, sec-butyl, tert-butyl, pentyl (e.g. n-pentyl or neopentyl), hexyl, heptyl, octyl, nonyl, decyl, dodecyl or stearyl, cycloalkyl groups such as cyclopropyl, cyclobutyl, cyclopentyl, cyclohexyl or adamantly, or aryl groups such as phenyl, naphthyl or anthracyl. In one embodiment, the alkyl groups may be optionally substituted with one or more (e.g. 1, 2, 3, 4, or 5) substituents each of which may be the same or different such as halide (F, Cl, Br or I) or alkoxy groups, e.g. methoxy, ethoxy or propoxy. The aryl group may be optionally substituted with one or more (e.g. 1, 2, 3, 4, or 5) substituents each of which may be the same or different such as halide (F, Cl, Br or I), straight- or branched-chain alkyl (e.g. C₁-C₁₀), alkoxy (e.g. C₁-C₁₀ alkoxy), straight- or branched-chain (dialkyl)amino (e.g. C₁-C₁₀ dialkyl)amino), heterocycloalkyl (e.g. C₃₋₁₀ heterocycloalkyl groups, such as morpholinyl and piperadinyl) or tri(halo)methyl (e.g. F₃C—). Suitable substituted aryl groups include but are not limited to 4-dimethylaminophenyl, 4-methylphenyl, 3,5-dimethylphenyl, 4-methoxyphenyl, 4-methoxy-3,5-dimethylphenyl and 3,5-di(trifluoromethyl)phenyl. Substituted or unsubstituted heteroaryl groups such as pyridyl may also be used. In one embodiment, R^{a} is methyl.

R^{b} may be selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen. In one embodiment, R^{b} is selected from the group consisting of unsubstituted C₁-C₂₀-alkyl, unsubstituted C₃-C₁₅-cycloalkyl, unsubstituted C₅-C₂₀-aryl, unsubstituted C₄-C₂₀-heteroaryl, wherein the heteroatoms in the C₄-C₂₀-heteroaryl are selected from the group consisting of sulfur, oxygen and nitrogen. In one embodiment, R^{b} is selected from the group consisting of unsubstituted C₁-C₂₀-alkyl, unsubstituted C₃-C₁₅-cycloalkyl, unsubstituted C₅-C₂₀-aryl, unsubstituted C₄-C₂₀-heteroaryl, wherein the heteroatoms in the C₄-C₂₀-heteroaryl are selected from the group consisting of sulfur, oxygen and nitrogen. R^{b} may be substituted or unsubstituted branched- or straight-chain alkyl groups such as methyl, ethyl, n-propyl, iso-propyl, n-butyl, iso-butyl, sec-butyl, tert-butyl, pentyl (e.g. n-pentyl or neopentyl), hexyl, heptyl, octyl, nonyl, decyl, dodecyl or stearyl, cycloalkyl groups such as cyclopropyl, cyclobutyl, cyclopentyl, cyclohexyl or adamantly, or aryl groups such as phenyl, naphthyl or anthracyl. In one embodiment, the alkyl groups may be optionally substituted with one or more (e.g. 1, 2, 3, 4, or 5) substituents each of which may be the same or different such as halide (F, Cl, Br or I) or alkoxy groups, e.g. methoxy, ethoxy or propoxy. The aryl group may be optionally substituted with one or more (e.g. 1, 2, 3, 4, or 5) substituents each of which may be the same or different such as halide (F, Cl, Br or I), straight- or branched-chain alkyl (e.g. C₁-C₁₀), alkoxy (e.g. C₁-C₁₀ alkoxy), straight- or branched-chain (dialkyl)amino (e.g. C₁-C₁₀ dialkyl)amino), heterocycloalkyl (e.g. C₃₋₁₀ heterocycloalkyl groups, such as morpholinyl and piperadinyl) or tri(halo)methyl (e.g. F₃C—). Suitable substituted aryl groups include but are not limited to 4-dimethylaminophenyl, 4-methylphenyl, 3,5-dimethylphenyl, 4-methoxyphenyl, 4-methoxy-3,5-dimethylphenyl and 3,5-di(trifluoromethyl)phenyl. Substituted or unsubstituted heteroaryl groups such as pyridyl may also be used.

R^{b} may be present or absent. When absent, m is 0 i.e. the R^{b}-containing Cp ring is not further substituted. When R^{b} is present, m may be 1, 2, 3 or 4. The or each R^{b} may be the same or different. In one embodiment, R^{b} is absent i.e. m is 0.

R^{c} may be selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen. In one embodiment, R^{c} is selected from the group consisting of unsubstituted C₁-C₂₀-alkyl, unsubstituted C₃-C₁₅-cycloalkyl, unsubstituted C₅-C₂₀-aryl, unsubstituted C₄-C₂₀-heteroaryl, wherein the heteroatoms in the C₄-C₂₀-heteroaryl are selected from the group consisting of sulfur, oxygen and nitrogen. In one embodiment, R^{c} is selected from the group consisting of unsubstituted C₁-C₂₀-alkyl, unsubstituted C₃-C₁₅-cycloalkyl, unsubstituted C₅-C₂₀-aryl, unsubstituted C₄-C₂₀-heteroaryl, wherein the heteroatoms in the C₄-C₂₀-heteroaryl are selected from the group consisting of sulfur, oxygen and nitrogen. R^{c} may be substituted or unsubstituted branched- or straight-chain alkyl groups such as methyl, ethyl, n-propyl, iso-propyl, n-butyl, iso-butyl, sec-butyl, tert-butyl, pentyl (e.g. n-pentyl or neopentyl), hexyl, heptyl, octyl, nonyl, decyl, dodecyl or stearyl, cycloalkyl groups such as cyclopropyl, cyclobutyl, cyclopentyl, cyclohexyl or adamantly, or aryl groups such as phenyl, naphthyl or anthracyl. In one embodiment, the alkyl groups may be optionally substituted with one or more (e.g. 1, 2, 3, 4, or 5) substituents each of which may be the same or different such as halide (F, Cl, Br or I) or alkoxy groups, e.g. methoxy, ethoxy or propoxy. The aryl group may be optionally substituted with one or more (e.g. 1, 2, 3, 4, or 5) substituents each of which may be the same or different such as halide (F, Cl, Br or I), straight- or branched-chain alkyl (e.g. C₁-C₁₀), alkoxy (e.g. C₁-C₁₀ alkoxy), straight- or branched-chain (dialkyl)amino (e.g. C₁-C₁₀ dialkyl)amino), heterocycloalkyl (e.g. C₃₋₁₀ heterocycloalkyl groups, such as morpholinyl and piperadinyl) or tri(halo)methyl (e.g. F₃C—). Suitable substituted aryl groups include but are not limited to 4-dimethylaminophenyl, 4-methylphenyl, 3,5-dimethylphenyl, 4-methoxyphenyl, 4-methoxy-3,5-dimethylphenyl and 3,5-di(trifluoromethyl)phenyl. Substituted or unsubstituted heteroaryl groups such as pyridyl may also be used.

R^{c} may be present or absent. When absent, n is 0 i.e. the R^{c}-containing Cp ring is not substituted.

When R^{c} is present, n may be 1, 2, 3, 4 or 5 when j is 0 or n may be 1, 2, 3 or 4 when j is 1.

The or each R^{c} may be the same or different. In one embodiment, R^{c} is absent i.e. n is 0.

R^{d} may be selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen. In one embodiment, R^{d} is selected from the group consisting of unsubstituted C₁-C₂₀-alkyl, unsubstituted C₃-C₁₅-cycloalkyl, unsubstituted C₅-C₂₀-aryl, unsubstituted C₄-C₂₀-heteroaryl, wherein the heteroatoms in the C₄-C₂₀-heteroaryl are selected from the group consisting of sulfur, oxygen and nitrogen. R^{d} may be substituted or unsubstituted branched- or straight-chain alkyl groups such as methyl, ethyl, n-propyl, iso-propyl, n-butyl, iso-butyl, sec-butyl, tert-butyl, pentyl (e.g. n-pentyl or neopentyl), hexyl, heptyl, octyl, nonyl, decyl, dodecyl or stearyl, cycloalkyl groups such as cyclopropyl, cyclobutyl, cyclopentyl, cyclohexyl or adamantly, or aryl groups such as phenyl, naphthyl or anthracyl. In one embodiment, the alkyl groups may be optionally substituted with one or more (e.g. 1, 2, 3, 4, or 5) substituents each of which may be the same or different such as halide (F, Cl, Br or I) or alkoxy groups, e.g. methoxy, ethoxy or propoxy. The aryl group may be optionally substituted with one or more (e.g. 1, 2, 3, 4, or 5) substituents each of which may be the same or different such as halide (F, Cl, Br or I), straight- or branched-chain alkyl (e.g. C₁-C₁₀), alkoxy (e.g. C₁-C₁₀ alkoxy), straight- or branched-chain (dialkyl)amino (e.g. C₁-C₁₀ dialkyl)amino), heterocycloalkyl (e.g. C₃₋₁₀ heterocycloalkyl groups, such as morpholinyl and piperadinyl) or tri(halo)methyl (e.g. F₃C—). Suitable substituted aryl groups include but are not limited to 4-dimethylaminophenyl, 4-methylphenyl, 3,5-dimethylphenyl, 4-methoxyphenyl, 4-methoxy-3,5-dimethylphenyl and 3,5-di(trifluoromethyl)phenyl. Substituted or unsubstituted heteroaryl groups such as pyridyl may also be used.

In one embodiment, R^{d} is absent and j is 0.

In one embodiment, R^{d} is methyl and j is 1.

R^{e} may be selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl. In one embodiment, R^{e} is selected from the group consisting of unsubstituted C₁-C₂₀-alkyl, unsubstituted C₃-C₁₅-cycloalkyl, unsubstituted C₅-C₂₀-aryl. R^{e} may be substituted or unsubstituted branched- or straight-chain alkyl groups such as methyl, ethyl, n-propyl, iso-propyl, n-butyl, iso-butyl, sec-butyl, tert-butyl, pentyl (e.g. n-pentyl or neopentyl), hexyl, heptyl, octyl, nonyl, decyl, dodecyl or stearyl, cycloalkyl groups such as cyclopropyl, cyclobutyl, cyclopentyl, cyclohexyl or adamantly, or aryl groups such as phenyl, naphthyl or anthracyl. In one embodiment, the alkyl groups may be optionally substituted with one or more (e.g. 1, 2, 3, 4, or 5) substituents each of which may be the same or different such as halide (F, Cl, Br or I) or alkoxy groups, e.g. methoxy, ethoxy or propoxy. The aryl group may be optionally substituted with one or more (e.g. 1, 2, 3, 4, or 5) substituents each of which may be the same or different such as halide (F, Cl, Br or I), straight- or branched-chain alkyl (e.g. C₁-C₁₀), alkoxy (e.g. C₁-C₁₀ alkoxy), straight- or branched-chain (dialkyl)amino (e.g. C₁-C₁₀ dialkyl)amino), heterocycloalkyl (e.g. C₃₋₁₀ heterocycloalkyl groups, such as morpholinyl and piperadinyl) or tri(halo)methyl (e.g. F₃C—). Suitable substituted aryl groups include but are not limited to 4-dimethylaminophenyl, 4-methylphenyl, 3,5-dimethylphenyl, 4-methoxyphenyl, 4-methoxy-3,5-dimethylphenyl and 3,5-di(trifluoromethyl)phenyl. Substituted or unsubstituted heteroaryl groups such as pyridyl may also be used. In one embodiment, R^{e} is methyl.

R^{f} may be selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl. In one embodiment, R^{f} is selected from the group consisting of unsubstituted C₁-C₂₀-alkyl, unsubstituted C₃-C₁₅-cycloalkyl, unsubstituted C₅-C₂₀-aryl. In one embodiment, R^{f} is selected from the group consisting of unsubstituted C₁-C₂₀-alkyl, unsubstituted C₃-C₁₅-cycloalkyl, unsubstituted C₅-C₂₀-aryl, unsubstituted C₄-C₂₀-heteroaryl, wherein the heteroatoms in the C₄-C₂₀-heteroaryl are selected from the group consisting of sulfur, oxygen and nitrogen. R^{f} may be substituted or unsubstituted branched- or straight-chain alkyl groups such as methyl, ethyl, n-propyl, iso-propyl, n-butyl, iso-butyl, sec-butyl, tert-butyl, pentyl (e.g. n-pentyl or neopentyl), hexyl, heptyl, octyl, nonyl, decyl, dodecyl or stearyl, cycloalkyl groups such as cyclopropyl, cyclobutyl, cyclopentyl, cyclohexyl or adamantly, or aryl groups such as phenyl, naphthyl or anthracyl. In one embodiment, the alkyl groups may be optionally substituted with one or more (e.g. 1, 2, 3, 4, or 5) substituents each of which may be the same or different such as halide (F, Cl, Br or I) or alkoxy groups, e.g. methoxy, ethoxy or propoxy. The aryl group may be optionally substituted with one or more (e.g. 1, 2, 3, 4, or 5) substituents each of which may be the same or different such as halide (F, Cl, Br or I), straight- or branched-chain alkyl (e.g. C₁-C₁₀), alkoxy (e.g. C₁-C₁₀ alkoxy), straight- or branched-chain (dialkyl)amino (e.g. C₁-C₁₀ dialkyl)amino), heterocycloalkyl (e.g. C₃₋₁₀ heterocycloalkyl groups, such as morpholinyl and piperadinyl) or tri(halo)methyl (e.g. F₃C—). Suitable substituted aryl groups include but are not limited to 4-dimethylaminophenyl, 4-methylphenyl, 3,5-dimethylphenyl, 4-methoxyphenyl, 4-methoxy-3,5-dimethylphenyl and 3,5-di(trifluoromethyl)phenyl. Substituted or unsubstituted heteroaryl groups such as pyridyl may also be used. In one embodiment, R^{f} is methyl.

M may be selected from the group consisting of Fe, Ru, Os and Ni. In one embodiment, M is Fe and the compound of formula (I) is a ferrocenyl compound. In another embodiment, M is Ru. In another embodiment, M is Os. In another embodiment, M is Ni. Preferably, M is Fe.

In one embodiment, j is 0, n is an integer from 1 to 5, k is 1 or 2 and the metallocenyl compound of formula (I), is represented by the formula (Ia):

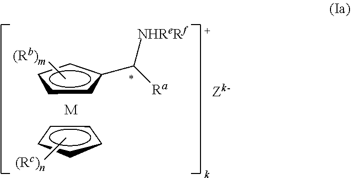

Z is a non-optically active anion and suitably may be selected from:
a) a monoatomic anion, such as a halide anion, in which case k=1; or
b) an oxyanion, such as (H₂PO₄)⁻ (k=1) or (HPO₄)²⁻ (k=2); or
c) a non optically active organic anion, such as:
   when k=1: CH₃CO₂⁻ (acetate), C₆H₅CO₂⁻ (benzoate), CH₃SO₃⁻ (mesylate), CH₃C₆H₄SO₂⁻ (tosylate), HO₂CCH═CHCO₂⁻ (monoanionic fumarate), HO₂C(CH₂)₄CO₂⁻ (monoanionic adipate), HO₂C—CO₂⁻ (monoanionic oxalate),
   when k=2: ⁻O₂CCH═CHCO₂⁻ (dianionic fumarate), ⁻O₂C(CH₂)₄CO₂⁻ (dianionic adipate), ⁻O₂C—CO₂⁻ (dianionic oxalate).

In one embodiment Z may be a monoanion (in which case k=1) or a dianion (in which case k=2).

In another embodiment, j is 1, n is an integer from 1 to 4, k is 1 and the metallocenyl compound of formula (I) is represented by the formula (Ib):

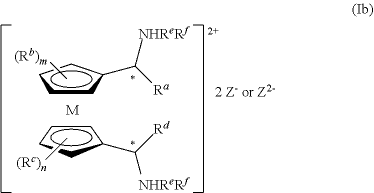

Z is a non-optically active anion and suitably may be selected from:
a) a monoatomic anion, such as a halide anion; or
b) an oxyanion, such as (H₂PO₄)⁻ or (HPO₄)²⁻; or
c) a non optically active organic anion, such as:
   CH₃CO₂⁻ (acetate), C₆H₅CO₂⁻ (benzoate), CH₃SO₃⁻ (mesylate), CH₃C₆H₄SO₂⁻ (tosylate), HO₂CCH═CHCO₂⁻ (monoanionic fumarate), HO₂C(CH₂)₄CO₂⁻ (monoanionic adipate), HO₂C—CO₂⁻ (monoanionic oxalate),
   ⁻O₂CCH═CHCO₂⁻ (dianionic fumarate), ⁻O₂C(CH₂)₄CO₂⁻ (dianionic adipate), ⁻O₂C—CO₂⁻ (dianionic oxalate).

Suitable metallocenyl compounds of formula (I) are salts of the N,N-dimethyl-α-ferrocenylethylammonium cation (A*), such as A*(H₂PO₄), A*₂(HPO₄) or mixtures thereof, A*(OAc), A*(benzoate), A*(mesylate), A*(tosylate), A*(fumarate), A*(adipate), A*(oxalate):

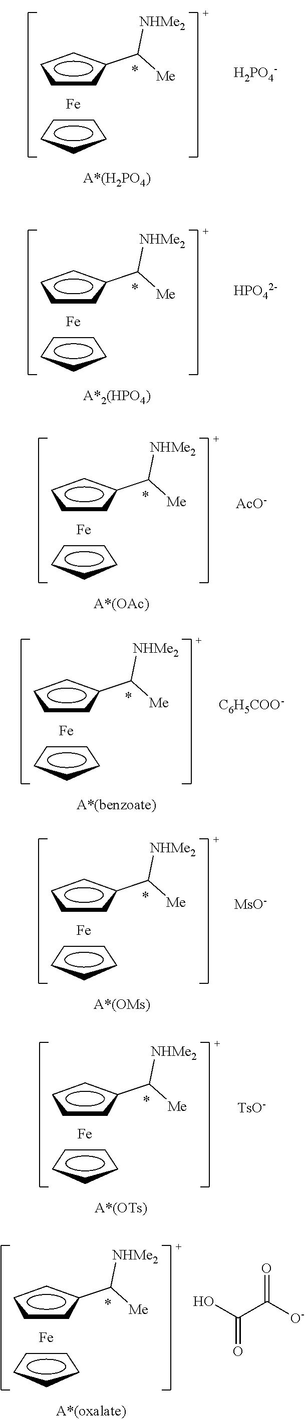

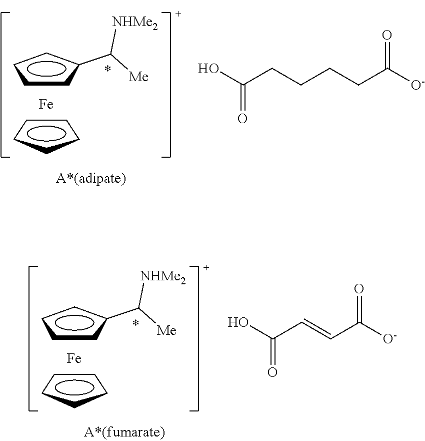

Preferred metallocenyl compounds of formula (I) are N,N-dimethyl-α-ferrocenylethylammonium dihydrogenphosphate (A*(H₂PO₄)), di(N,N-dimethyl-α-ferrocenylethylammonium monohydrogenphosphate (A*₂(HPO₄)) or mixtures thereof.

In another aspect, the present invention provides a process for the preparation of a metallocenyl compound of formula (I)

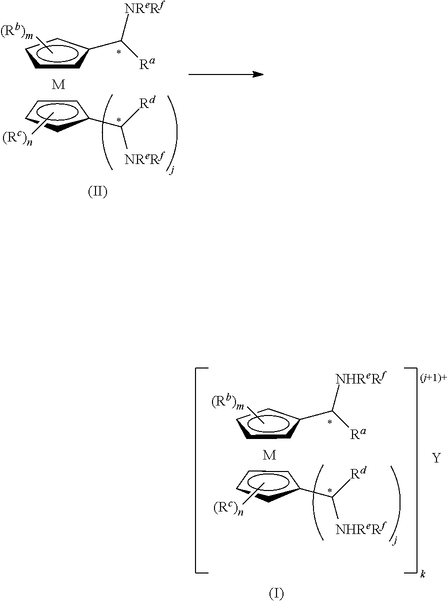

comprising mixing a compound of formula (II) with an acid Hₖ₍ⱼ₊₁₎Z in a solvent to form a compound of formula (I),
wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} Or Z^{(j+1)k-};
Z is a non optically active anion; and
* denotes an optically active carbon atom.

The acid Hₖ₍ⱼ₊₁₎Z may be a corresponding acid of the non-optically active anion Z⁻ or Z²⁻ in the compound of formula (I). In one embodiment, the acid Hₖ₍ⱼ₊₁₎Z may be H₃PO₄, fumaric acid, adipic acid, oxalic acid, benzoic acid, acetic acid, methanesulfonic acid and p-toluenesulfonic acid. In one preferred embodiment, the acid Hₖ₍ⱼ₊₁₎Z may be H₃PO₄.

The process according to the invention may be carried out in the presence of a solvent. Preferably, the solvent comprises, an alcohol, an ether (cyclic or open chain, such as tetrahydrofuran (THF) or methyl tert-butylether (MTBE)), an aromatic solvent (such as benzene or toluene), an ester (such as ethyl acetate) or a combination thereof. When the solvent comprises an alcohol, preferred alcohols have boiling points at atmospheric pressure (i.e. 1.0135×10⁵ Pa) below 160° C., more preferably below 120° C. and even more preferably below 100° C. Preferred examples are methanol, ethanol, n-propanol, isopropanol, n-butanol or combinations thereof. More preferably, the alcohol is methanol, isopropanol or a combination thereof. Particular preference is given to methanol.

The concentration of compound of formula (II) may be in the range of. 0.1-5 M, preferably 0.9 M to about 1.2 M. In one embodiment, the concentration of compound of formula (II) is about 1.1 M. The concentration of Hₖ₍ⱼ₊₁₎Z may be in the range of 0.5 M to about 1 M. In one embodiment, the concentration of Hₖ₍ⱼ₊₁₎Z is about 0.9 M. In another embodiment, the concentration of Hₖ₍ⱼ₊₁₎Z is about 0.6 M.

The reactants may be added in any suitable order, but in a preferred process of the invention a diluted aqueous solution of the Hₖ₍ⱼ₊₁₎Z is added to a solution of the compound of formula (II) in the solvent. It is desirable that the diluted aqueous solution of the Hₖ₍ⱼ₊₁₎Z is added to the solution of the compound of formula (II) slowly in order to avoid an uncontrollable exotherm.

In the present invention, the ratio between the compound of formula (II) and Hₖ₍ⱼ₊₁₎Z determines the composition and purity of the metallocenyl compound of formula (I). When j=0 and k=1 the ratio between the compound of formula (II) and the number of equivalents of Hₖ₍ⱼ₊₁₎Z may be in the range of about 0.8:1 to about 1.25:1 and a mixture of unreacted compound of formula (II) and a compound of formula (I) wherein k=1 may be formed. Suitable ratios between compound of formula (II) and the number of equivalents of Hₖ₍ⱼ₊₁₎Z include but are not limited to 0.80:1, 0.85:1, 0.90:1, 0.95:1, 1.00:1, 1.05:1, 1.10:1, 1.15:1, 1.20:1, 1.25:1.

Where j=0 and k is 2 or where j=1 and k=1 the ratio between the compound of formula (II) and the number of equivalents of Hₖ₍ⱼ₊₁₎Z may be in the range of about 1.15:1 to about 2.20:1 and a mixture of a compound of formula (I) wherein k=1 and a compound of formula (I) wherein k=2 may be formed. Suitable ratios between compound of formula (II) and the number of equivalents of Hₖ₍ⱼ₊₁₎Z include but are not limited to 1.15:1, 1.20:1, 1.25:1, 1.30:1, 1.35:1, 1.40:1, 1.45:1, 1.50:1, 1.55:1, 1.60:1, 1.65:1, 1.70:1, 1.75:1, 1.80:1, 1.85:1, 1.90:1, 1.95:1, 2.00:1, 2.05:1, 2.10:1, 2.15:1, 2.20:1.

While Hₖ₍ⱼ₊₁₎Z is added to the compound of formula (II), it is preferred that the temperature range of the reaction mixture may be maintained at one or more temperatures between about −15° C. to about 35° C. In one embodiment the reaction mixture is maintained at a temperature of between about −10° C. to about 10° C. In another embodiment, the reaction mixture is maintained at a temperature of less than about 5° C. In one preferred embodiment, the reaction mixture is maintained at 0° C.

The reaction may be continued for a period of from about 30 minutes to about 2 hours, preferably about 1 hour. During this time, the reaction temperature may be varied one or more times between about −10° C. and about 60° C.

Alternatively, Hₖ₍ⱼ₊₁₎Z may be added to the compound of formula (II) at a temperature below 160° C., more preferably below 120° C. and even more preferably below 100° C. The reaction may be continued for a period of from about 30 minutes to about 2 hours, preferably about 1 hour. During this time, the reaction temperature may be varied one or more times between about 160° C. and about 15° C.

On completion of the reaction, the compound of formula (I) may be separated from the reaction mixture by any appropriate method.

Purification of the complex of formula (I) is not normally required, although if necessary it is possible to purify the complex using conventional procedures.

In one embodiment, the present invention further comprises the step of treating the metallocenyl complex of formula (I) with a base to form the complex of formula (II). The metallocenyl complex of formula (I) is preferably mixed with a solvent to obtain a suspension. The solvent may be any suitable solvent, for example an aromatic hydrocarbon (such as toluene). The base is preferably an aqueous solution of an alkali hydroxide. The base may be added until the pH of the liquid will be in the range of about 10 to about 11. On completion of the reaction, the compound of formula (II) may be separated from the reaction mixture by any appropriate method. Determination of the enantiomeric excess is carried out on a sample of the compound of formula (II) by analysing it by HPLC.

In another aspect, the present invention provides a process for increasing the optical purity of a compound of formula (II),

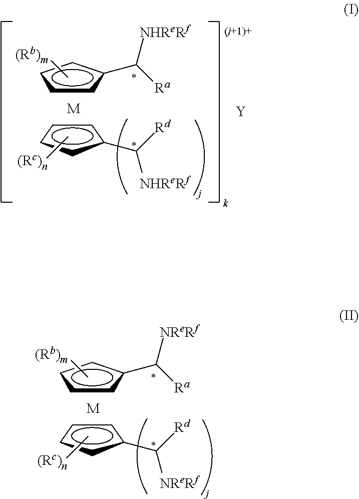

comprising the steps of:
a) mixing a metallocenyl compound of formula (I) with a solvent to obtain a suspension of solid particles in a liquid, wherein the mixing is carried out at about the boiling point of the solvent;
b) separating metallocenyl compound of formula (I) as a solid from the suspension of step a).
c) obtaining the compound of formula (II) from the metallocenyl compound of formula (I) of step b) in the presence of a base,
wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} or Z^{(j+1)k-};
Z is a non optically active anion; and
* denotes an optically active carbon atom.

In one embodiment, the process for the preparation of a metallocenyl compound of formula (I) previously described further comprises a process for increasing the optical purity of the compound of formula (II),

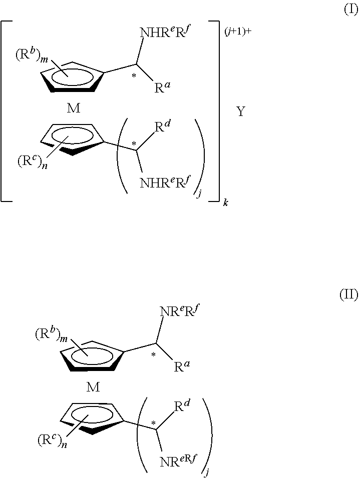

comprising the steps of:
a) mixing the metallocenyl compound of formula (I) with a solvent to obtain a suspension of solid particles in a liquid, wherein the mixing is carried out at about the boiling point of the solvent;
b) separating metallocenyl compound of formula (I) as a solid from the suspension of step a).
c) obtaining the compound of formula (II) from the metallocenyl compound of formula (I) of step b) in the presence of a base.

R^{a}, R^{b}, R^{c}, R^{d}, R^{e}, R^{f}, M, Y, Z, m, n, j and k are as generally described above.

A preferred compound of formula (I) is compound A*(H₂PO₄) and a preferred compound of formula (II) is compound B:

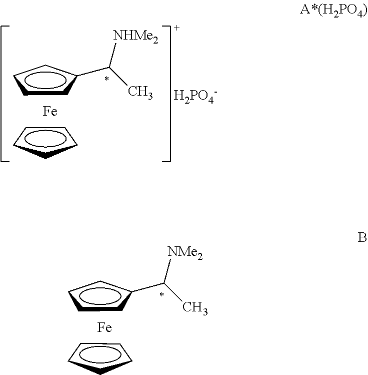

When compound of formula (I) is compound A*(H₂PO₄) and compound of formula (II) is compound B, the solvent comprises an alcohol. Preferred alcohols have boiling points at atmospheric pressure (i.e. 1.0135×10⁵ Pa) below 160° C., more preferably below 120° C. and even more preferably below 100° C. Preferred examples are methanol, ethanol, n-propanol, isopropanol, n-butanol or combinations thereof. More preferably, the alcohol is methanol, isopropanol or a combination thereof. Particular preference is given to a mixture of isopropanol/methanol 99/1.

Compound A*(H₂PO₄) is separated as a solid from the suspension and isolated using conventional procedures, such as filtration.

Isolated compound A*(H₂PO₄) is treated in a suitable solvent, such as toluene, with a base.

The preferred base is NaOH 2M. The base may be added until the pH of the liquid will be in the range of about 10 to about 11. On completion of the reaction, compound B may be separated from the reaction mixture by any appropriate method, such as separating the organic layer from the aqueous layer and isolating compound B from the organic layer.

Determination of the enantiomeric excess is carried out on a sample of the compound B by analysing it by HPLC. The enantiomeric excess of compound B may be ≥99% ee.

In an embodiment, the compound of formula (II) is prepared by mixing a compound of formula (III) with a compound of formula HNR^{e}R^{f} in a solvent to form the compound of formula (II),

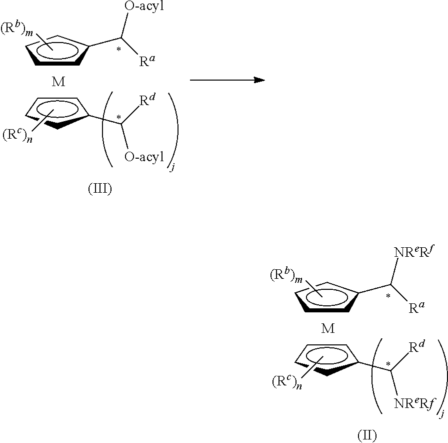

wherein
R^{a}, R^{b}, R^{c} and R^{d} are independently selected from the group consisting of unsubstituted C₁-C₂₀-alkyl, substituted C₁-C₂₀-alkyl, unsubstituted C₃-C_{1Pa}-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5;
when j=1, n is an integer from 0 to 4; and
* denotes an optically active carbon atom.

The molar ratio of compound of formula (III):HNR^{e}R^{f} when j=0 may be in the range of about 1:10 to about 1:4, preferably of about 1:6 to about 1:4. In one embodiment, the molar ratio of compound of formula (III):HNR^{e}R^{f} may be in the range of about 1:5.5 to 1:4.5. In one preferred embodiment, the ratio is about 1:5. When j=1, the molar ratio of compound of formula (III):HNR^{e}R^{f} may be in the range of about 1:20 to about 1:8, preferably of about 1:12 to about 1:8. In one embodiment, the molar ratio of compound of formula (III):HNR^{e}R^{f} may be in the range of about 1:11 to 1:9. In one preferred embodiment, the ratio is about 1:10.

The process according to the invention may be carried out in the presence of a solvent. Preferably, the solvent comprises a mixture of alcohol and a C₁-C₈ alkane. The solvent may further comprise water. Preferred alcohols have boiling points at atmospheric pressure (i.e. 1.0135×10⁵ Pa) below 160° C., more preferably below 120° C. and even more preferably below 100° C. Preferred examples are methanol, ethanol, n-propanol, isopropanol, n-butanol or combinations thereof. More preferably, the alcohol is methanol, isopropanol or a combination thereof. Particular preference is given to isopropanol. The C₁-C₈ alkane may be a linear alkane, a branched alkane or a cycloalkane. Suitable alkanes are pentane (all isomers), hexane (all isomers), heptane (all isomers), octane (all isomers) or mixtures thereof. The most preferred alkanes are heptane and cyclohexane.

The ratio alcohol:C₁-C₈ alkane may be in the range of about 1:3 to about 1:8 preferably about 1:4 to about 1:7, most preferably 1:5.

The reactants may be added in any suitable order, but in a preferred process of the invention a solution of the compound of formula HNR^{e}R^{f} in water or alcohol is added to the solution of the compound of formula (III) in the solvent. It is desirable that the solution of the HNR^{e}R^{f} is added to the solution of the compound of formula (III) slowly in order to avoid an uncontrollable exotherm.

While HNR^{e}R^{f} is added to the compound of formula (III), it is preferred that the temperature range of the reaction mixture may be maintained at one or more temperatures between about −15° C. to about 35° C. In one embodiment the reaction mixture is maintained at a temperature of between about −10° C. to about 10° C. In another embodiment, the reaction mixture is maintained at a temperature of less than about 5° C. In one preferred embodiment, the reaction mixture is maintained at 0° C.

The reaction may be continued for a period of from about 30 minutes to about 24 hours, preferably about 10 hours. During this time, the reaction temperature may be varied one or more times between about −10° C. and about 65° C., preferably about 50° C. On completion of the reaction, the compound of formula (II) may be separated from the reaction mixture by any appropriate method. Purification of the complex of formula (II) is not normally required, although if necessary it is possible to purify the complex using conventional procedures.

In an embodiment, the compound of formula (III) is prepared by mixing a compound of formula (IV) with a compound of formula acyl-LG in the presence of a base to form a compound of formula (III), wherein LG is a leaving group:

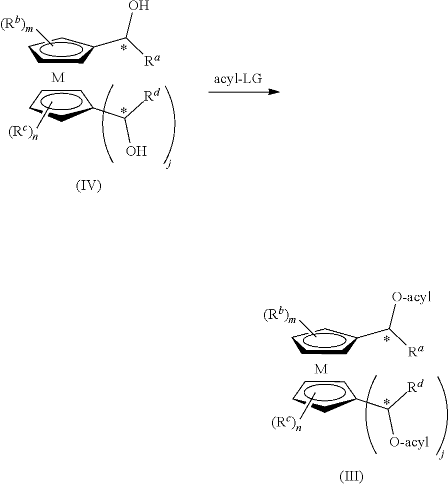

The compound of formula acyl-LG is preferably a carboxylic anhydride or an acyl chloride. In these instances, LG may be —O-acyl (for carboxylic anhydride), or —Cl (for acyl chloride). The most preferred compound of formula acyl-LG is acetic anhydride.

The base may be an organic or an inorganic base. Preferably, the base is sodium acetate. The most preferred base is sodium acetate trihydrate (NaOAc-3.H₂O).

The reaction may be carried out in the absence of a solvent (neat). In these instances, the compound of formula acyl-LG acts as a solvent. Suitable compounds of formula acyl-LG are preferably a carboxylic anhydride.

Alternatively, the reaction may be carried out in the presence of a solvent. The solvent may be any suitable aprotic solvent. The solvent may be selected from the group consisting of an aromatic solvent (such as benzene or toluene), an ether (cyclic, such as tetrahydrofuran (THF) or open chain, such as methyl tert-butylether (MTBE)), an ester (such as ethyl acetate, isopropyl acetate), a C₁-C₈ alkane (such as pentane, hexane, heptane, octane or mixtures thereof), dichloromethane, acetonitrile, acetone or a combination thereof. In a preferred embodiment the solvent is heptane.

The compound of formula (IV) and the compound of formula acyl-LG may be added in any suitable order. In a preferred process of the invention, however, the compound of formula (IV) and the base is placed in a reaction vessel, together with the solvent (if used), and then the compound of formula acyl-LG is added.

When j=0, the molar ratio between the compound of formula (IV) and the compound of formula acyl-LG may be in the range of about 1:1 to about 1:5. Preferably the molar ratios between compound of formula (IV) and the compound of formula acyl-LG may be in the range of about 1:1.5 to about 1:2 When j=1, the molar ratio between the compound of formula (IV) and the compound of formula acyl-LG may be in the range of about 1:2.2-1:8. Preferably the molar ratios between compound of formula (IV) and the compound of formula acyl-LG may be in the range of about 1:2.2-1:2.6.

The base may be added in a molar ratio compound of formula (IV) to the base of between about 1:0.1 to 1:5.

Alternatively, the base is dimethylaminopyridine (DMAP).

In one embodiment, the compound of formula (IV) is prepared by asymmetric transfer hydrogenation (ATH) of a metallocenyl compound of formula (V)

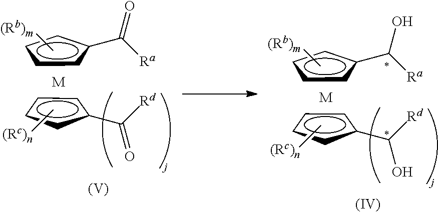

wherein:
the asymmetric transfer hydrogenation is carried out in an aqueous solvent at a temperature greater than 60° C. in the presence of an asymmetric transfer hydrogenation catalyst and activated formic acid; wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl;
M is selected from the group consisting of Fe, Ru, Os and Ni;
m is an integer from 0 to 4;
j is 0 or 1; and
when j=0, n is an integer from 0 to 5;
when j=1, n is an integer from 0 to 4; and
* denotes an optically active carbon atom.

A preferred compound of formula (I) is compound A*(H₂PO₄), a preferred compound of formula (II) is compound B, a preferred compound of formula (III) is compound C and a preferred compound of formula (IV) is compound D:

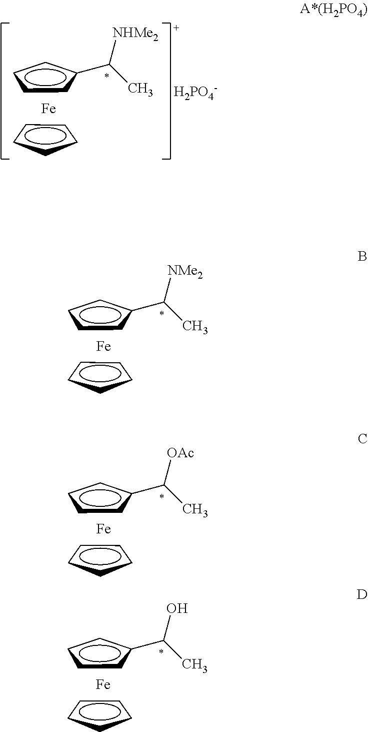

In one embodiment, the compound of formula (III) is compound C, the compound of formula (IV) is compound D and dimethylaminopyridine (DMAP) may be used as a base in the process of preparing compound C from compound D.

In this instance, compound A*(H₂PO₄) can be isolated free of impurities, such as DMAP-H₃PO₄ and DMAP-HOAc, by further purification comprising the steps of:
a) adding methanol to a compound A*(H₂PO₄) containing DMAP-H₃PO₄ and DMAP-HOAc, to produce a solid-liquid mixture;
b) separating the liquid containing the compound A*(H₂PO₄) and DMAP-HOAc from the solid-liquid mixture of step a);
c) isolating the compound A*(H₂PO₄) containing DMAP-HOAc from the liquid of step b);
d) adding dichloromethane or acetonitrile to the isolated compound A*(H₂PO₄) containing DMAP-HOAc of step c), to produce a second solid-liquid mixture;
e) isolating the solid from the second solid-liquid mixture of step d) to produce a compound A*(H₂PO₄) of higher purity than before the steps a) to e).

In one embodiment, the compound of formula (III) is obtained in situ, therefore without further isolation, before reaction with the compound of formula HNR^{e}R^{f}.

Metallocenyl Compounds of Formula (IV) and (V)

The metallocenyl carbonyl compound of formula (V) is asymmetrically reduced to the metallocenyl alcohol of formula (IV):

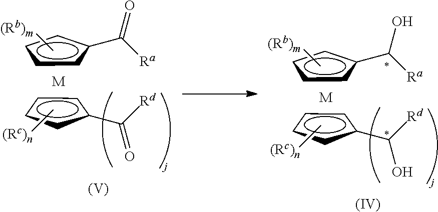

R^{a}, R^{b}, R^{c}, R^{d}, M, m, n and j are as generally described above.

Asymmetric Transfer Hydrogenation Catalyst

The asymmetric transfer hydrogenation catalyst may be a complex of formula (VI). The complex of formula (VI) may be referred to herein as a tethered complex.

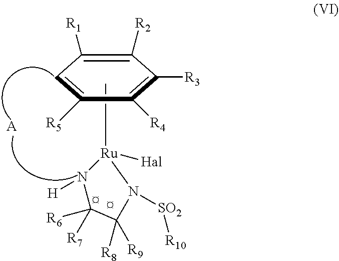

wherein,
R₁, R₂, R₃, R₄ and R₅ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, CN, —NR₂₀R₂₁, —COOH, COOR₂₀, —CONH₂, —CONR₂₀R₂₁ and —CF₃ wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₃₀R₃₁, —COOR₃₀, —CONR₃₀R₃₁ and —CF₃; and/or
R₁ and R₂, R₂ and R₃, R₃ and R₄ or R₄ and R₅ together form an aromatic ring composed of 6 to 10 carbon atoms which is optionally substituted with one or more straight C₁₋₂₀ alkyl, branched or cyclic C₃₋₂₀ alkyl, optionally substituted straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃;
R₆, R₇, R₈ and R₉ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl and optionally substituted C₆₋₂₀ aryloxy wherein the substituents are selected from the group consisting of one or more straight C₁₋₂₀ alkyl, branched or cyclic C₃₋₂₀ alkyl, optionally substituted straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃, or
R₆ and R₇ together with the carbon atom to which they are bound and/or R₈ and R₉ together with the carbon atom to which they are bound form an optionally substituted C₃₋₂₀ cycloalkyl or an optionally substituted C₂₋₂₀ cycloalkoxy, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃, or one of R₆ and R₇ and one of R₈ and R₉ together form an optionally substituted C₅₋₁₀ cycloalkyl or an optionally substituted C₅₋₁₀ cycloalkoxy, wherein the substituents are independently selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃,
provided R₆ and R₇ and/or R₈ and R₉ are not the same,
¤ represents an optically active carbon atom;
R₁₀ is an optionally substituted straight C₁₋₂₀ alkyl, branched or cyclic C₃₋₂₀ alkyl, an optionally substituted C₆₋₁₀ aryl or —NR₁₁R₁₂ wherein the substituents are selected from the group consisting of one or more straight, branched or cyclic C₁₋₁₀ alkyl, straight, branched or cyclic C₁₋₁₀ alkoxy, C₆₋₁₀ aryl, C₆₋₁₀ aryloxy, -Hal, —OH, —CN, —NR₂₀R₂₁, —COOR₂₀, —CONR₂₀R₂₁ and —CF₃;
R₁₁ and R₁₂ are independently selected from the group consisting of hydrogen, optionally substituted straight C₁₋₂₀ alkyl, branched or cyclic C₃₋₂₀ alkyl and optionally substituted C₆₋₁₀ aryl, wherein the substituents are selected from the group consisting of one or more straight C₁₋₂₀ alkyl, branched or cyclic C₃₋₂₀ alkyl groups, straight, branched or cyclic C₁₋₁₀ alkoxy, C₆₋₁₀ aryl, C₆₋₁₀ aryloxy, —OH, —CN, —NR₂₀R₂₁, —COOR₂₀, —CONR₂₀R₂₁ and —CF₃, or
R₁₁ and R₁₂ together with the nitrogen atom to which they are bound form an optionally substituted C₂₋₁₀ cycloalkyl-amino group, wherein the substituents are selected from the group consisting of one or more straight C₁₋₂₀ alkyl, branched or cyclic C₃₋₂₀ alkyl, straight, branched or cyclic C₁₋₁₀ alkoxy, C₆₋₁₀ aryl, C₆₋₁₀ aryloxy, —OH, —CN, —NR₂₀R₂₁, —COOR₂₀, —CONR₂₀R₂₁ and —CF₃;
R₂₀ and R₂₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN, —NR₃₀R₃₁, —COOR₃₀, —CONR₃₀R₃₁ and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
R₃₀ and R₃₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
A is an optionally substituted straight- or branched-chain C₂₋₅ alkyl wherein the substituents are selected from the group consisting of one or more straight C₁₋₂₀ alkyl, branched or cyclic C₃₋₂₀ alkyl, straight, branched or cyclic C₁₋₁₀ alkoxy, C₆₋₁₀ aryl and C₆₋₁₀ aryloxy, or
A is a group of formula (VII):

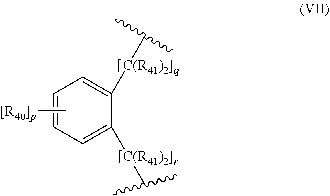

wherein p is an integer selected from 1, 2, 3 or 4;
each R₄₀ is independently selected from the group consisting of straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN or —CF₃;
q and r are independently integers selected from 0, 1, 2 or 3 wherein q+r=1, 2 or 3; each R₄₁ is independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃; or
A is a group of formula (VIII):

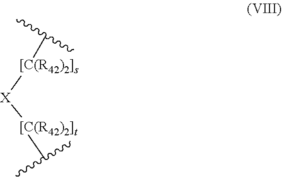

### X is O or S;

s and t are independently integers selected from 0, 1, 2 or 3 wherein s+t=1, 2 or 3;
each R₄₂ is independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
and
Hal is a halogen.

The carbon atoms to which R₆ and R₇ and/or R₈ and R₉ are bound are asymmetric when R₆ and R₇ and/or R₈ and R₉ are not the same groups. In one embodiment, R₆ and R₇ are not the same groups. In another embodiment, R₈ and R₉ are not the same groups. The asymmetric carbon atoms are represented by the symbol “n”. The complex of formula (VI) therefore is chiral (optically active) and the transfer hydrogenation process of the invention is an asymmetric transfer hydrogenation process.

R₁, R₂, R₃, R₄ and R₅ may each be independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOH, COOR₂₀, —CONH₂, —CONR₂₀R₂₁ and —CF₃. In another embodiment, R₁, R₂, R₃, R₄ and R₅ are each independently selected from the group consisting of hydrogen, straight- or branched-chain C₁₋₁₀ alkyl, straight- or branched-chain C₁₋₁₀ alkoxy, C₆₋₁₀ aryl, C₆₋₁₀ aryloxy and —OH. Preferably, R₁, R₂, R₃, R₄ and R₅ are each independently selected from the group consisting of hydrogen, straight-chain C₁₋₁₀ alkyl and branched-chain C₁₋₁₀ alkyl. R₁, R₂, R₃, R₄ and R₅ may be each independently selected from the group consisting of hydrogen, methyl, ethyl, n-propyl, i-propyl, n-butyl, i-butyl, s-butyl and t-butyl. For example, R₁, R₂, R₃, R₄ and R₅ may each be hydrogen. In another embodiment, R₃ may be methyl and R₁, R₂, R₄ and R₅ may each be hydrogen.

In yet another embodiment, R₆, R₇, R₈ and R₉ are each independently selected from the group consisting of hydrogen, optionally substituted straight- or branched-chain C₁₋₁₀ alkyl, optionally substituted straight- or branched-chain C₁₋₁₀ alkoxy, optionally substituted C₆₋₁₀ aryl and optionally substituted C₆-10 aryloxy wherein the substituents are selected from the group consisting of straight- or branched-chain C₁₋₁₀ alkyl, straight- or branched-chain C₁₋₁₀ alkoxy, C₆₋₁₀ aryl, C₆₋₁₀ aryloxy and —OH. The groups R₆, R₇, R₈ and R₉ may be each independently selected from the group consisting of hydrogen and optionally substituted C₆₋₁₀ aryl. For example, R₆, R₇, R₈ and R₉ may each be independently selected from the group consisting of hydrogen or phenyl. In one embodiment, one of R₆ and R₇ is phenyl and the other of R₆ and R₇ is hydrogen. In one embodiment, one of R₈ and R₉ is phenyl and the other of R₈ and R₉ is hydrogen.

In another embodiment, R₆ and R₇ together with the carbon atom to which they are bound and/or R₈ and R₉ together with the carbon atom to which they are bound form an optionally substituted C₅₋₁₀ cycloalkyl or an optionally substituted C₅₋₁₀ cycloalkoxy, wherein the substituents are selected from the group consisting of straight- or branched-chain C₁₋₁₀, straight- or branched-chain C₁₋₁₀ alkoxy, C₆₋₁₀ aryl, C₆₋₁₀ aryloxy and —OH.

In yet another embodiment, one of R₆ and R₇ and one of R₈ and R₉ together form an optionally substituted C₅₋₁₀ cycloalkyl or an optionally substituted C₅₋₁₀ cycloalkoxy, wherein the substituents are selected from the group consisting of straight- or branched-chain C₁₋₁₀ alkyl, straight- or branched-chain C₁₋₁₀ alkoxy, C₆₋₁₀ aryl, C₆₋₁₀ aryloxy and —OH.

In yet another embodiment, R₁₀ is an optionally substituted straight, branched or cyclic C₁₋₁₀ alkyl, an optionally substituted C₆₋₁₀ aryl wherein the substituents are selected from the group consisting of one or more straight, branched or cyclic C₁₋₁₀ alkyl, straight, branched or cyclic C₁₋₁₀ alkoxy, C₆₋₁₀ aryl, C₆₋₁₀ aryloxy, -Hal, —OH, —CN, —NR₂₀R₂₁, —COOR₂₀, —CONR₂₀R₂₁ and —CF₃. In another embodiment, the substituents are selected from the group consisting of one or more straight, branched or cyclic C₁₋₁₀ alkyl, straight, branched or cyclic C₁₋₁₀ alkoxy, C₆₋₁₀ aryl, C₆₋₁₀ aryloxy, -Hal, or —CF₃. In another embodiment, R₁₀ is a straight- or branched-chain C₁₋₁₀ alkyl or a C₆₋₁₀ aryl optionally substituted with one or more straight- or branched-chain C₁₋₁₀ alkyl groups. Examples of R₁₀ include, but are not limited to, p-tolyl, methyl, p-methoxyphenyl, p-chlorophenyl, trifluoromethyl, 3,5-dimethylphenyl, 2,4,6-trimethylphenyl, 2,4,6-triisopropylphenyl, 4-tert-butylphenyl, pentamethylphenyl and 2-naphthyl. R₁₀ may be methyl or a tolyl group.

In another embodiment, R₁₀ is —NR₁₁R₁₂ wherein R₁₁ and R₁₂ are independently selected from the group consisting of straight- or branched-chain C₁₋₁₀ alkyl and C₆₋₁₀ aryl optionally substituted with one or more straight- or branched-chain C₁₋₁₀ alkyl groups. —NR₁₁R₁₂ may be —NMe₂.

In yet another embodiment, R₁₁ and R₁₂ together with the nitrogen atom to which they are bound form an optionally substituted C₅₋₁₀ cycloalkyl-amino group wherein the substituents are selected from the group consisting of straight- or branched-chain C₁₋₁₀ alkyl, straight- or branched-chain C₁₋₁₀ alkoxy, C₆₋₁₀ aryl, C₆₋₁₀ aryloxy and —OH.

In one embodiment, A is an optionally substituted straight- or branched-chain C₂₋₅ alkyl, preferably an optionally substituted straight- or branched-chain C₃₋₅ alkyl, wherein the substituents are selected from the group consisting of straight- or branched-chain C₁₋₁₀ alkyl, straight- or branched-chain C₁₋₁₀ alkoxy, C₆₋₁₀ aryl and C₆₋₁₀ aryloxy. A may be selected from —(CH₂)₂—, —(CH₂)₃—, —(CH₂)₄— or —(CH₂)₅—, for example, —(CH₂)₃— or —(CH₂)₄—.

Alternatively, A can be a group of formula (VII) i.e. the —[C(R₄₁)₂]_{q}— and —[C(R₄₁)₂]ᵣ— groups are ortho to each other.

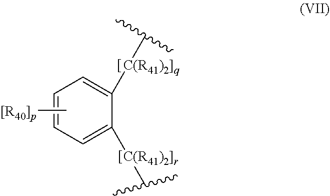

wherein p is an integer selected from 1, 2, 3 or 4;
each R₄₀ is independently selected from the group consisting of straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN or —CF₃;
q and r are independently integers selected from 0, 1, 2 or 3 wherein q+r=1, 2 or 3; and
each R₄₁ is independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN or —CF₃.

In one embodiment, p is 0. The phenyl ring therefore is not substituted by any R₄₀ groups.

In another embodiment, each R₄₁ are independently selected from the group consisting of hydrogen, straight-chain C₁₋₁₀ alkyl and branched-chain C₁₋₁₀ alkyl. More preferably, each R₄₁ are each independently selected from the group consisting of hydrogen, methyl, ethyl, n-propyl, i-propyl, n-butyl, i-butyl, s-butyl and t-butyl. In one embodiment, each R₄₁ is hydrogen.

In one embodiment, q+r is 1. In another embodiment, q+r is 2. In yet another embodiment, q+r is 3.

Examples of A include, but are not limited to, the following:

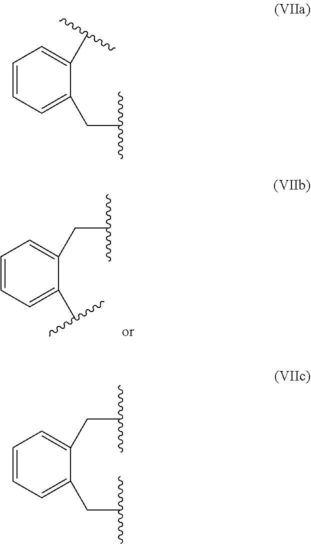 [SMILES: *Cc1ccccc1* ; *Cc1ccccc1* ; *Cc1ccccc1C*]

In another embodiment, A is a group of formula (VIII):

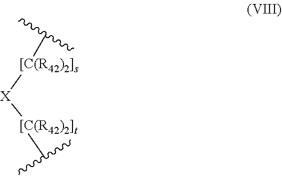

wherein X is O or S;
s and t are independently integers selected from 0, 1, 2 or 3 wherein s+t=1, 2 or 3;
each R₄₂ is independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃.

In one embodiment, s+t may be 1. In another embodiment, s+t may be 2. In yet another embodiment, s+t may be 3.

In one embodiment, X is O i.e. an oxygen atom. In another embodiment, X is S i.e. a sulfur atom.

In another embodiment, each R₄₂ are independently selected from the group consisting of hydrogen, straight-chain C₁₋₁₀ alkyl and branched-chain C₁₋₁₀ alkyl. More preferably, each R₄₂ are each independently selected from the group consisting of hydrogen, methyl, ethyl, n-propyl, i-propyl, n-butyl, i-butyl, s-butyl and t-butyl. In one embodiment, each R₄₂ is hydrogen.

Examples of A include, but are not limited to, the following:

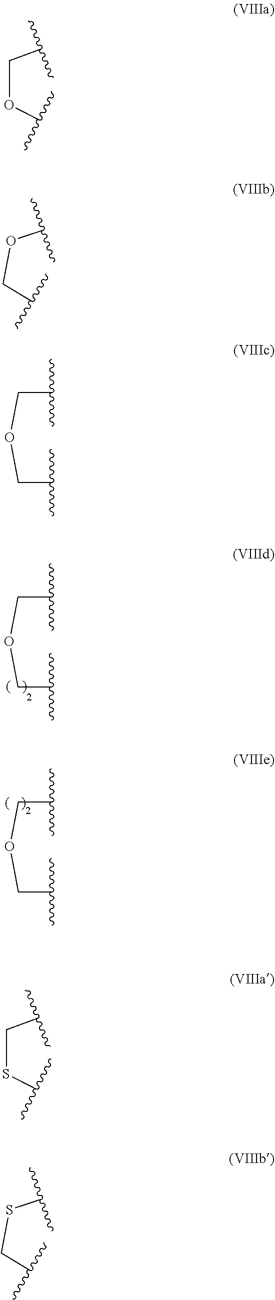

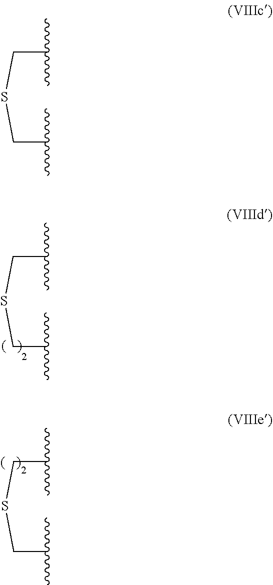

In one embodiment, A includes but is not limited to:

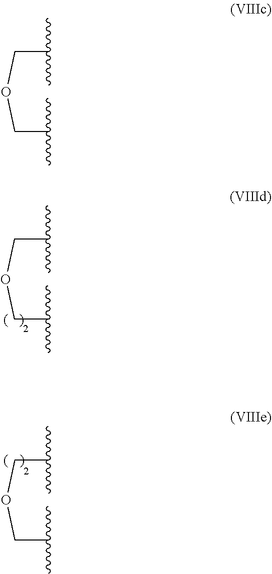

In one embodiment, Hal is chlorine, bromine or iodine, preferably chlorine.

The metal complexes of formula (VI) may be selected from the group consisting of:

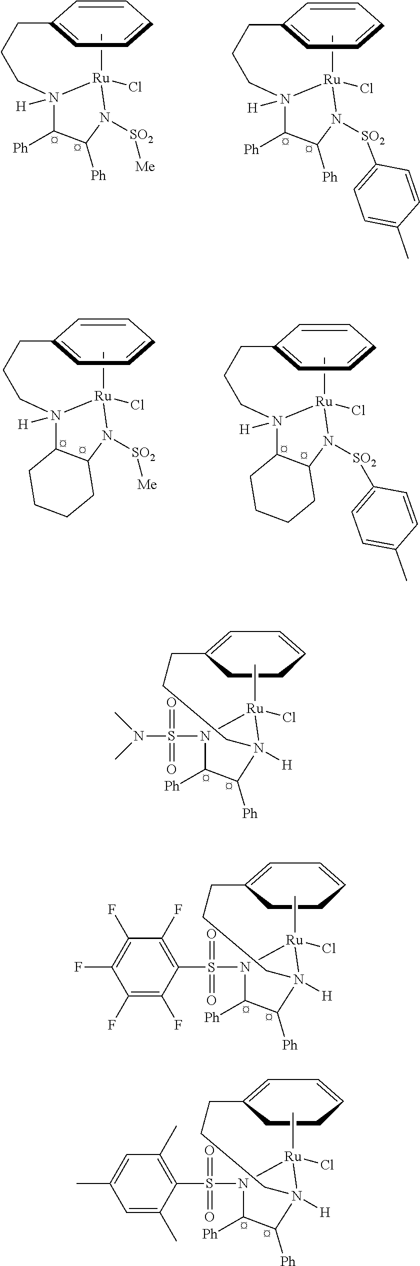

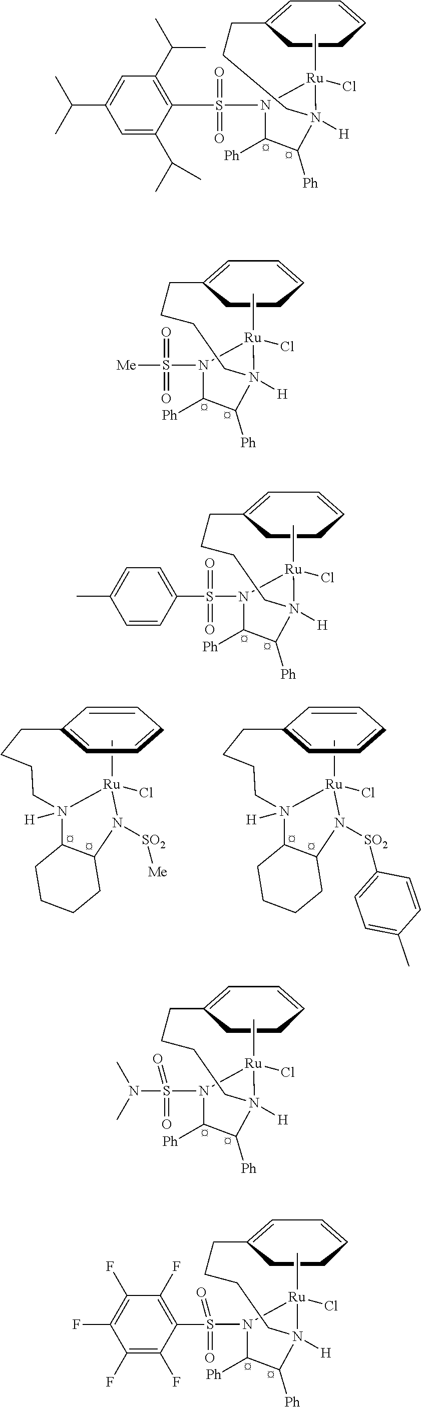

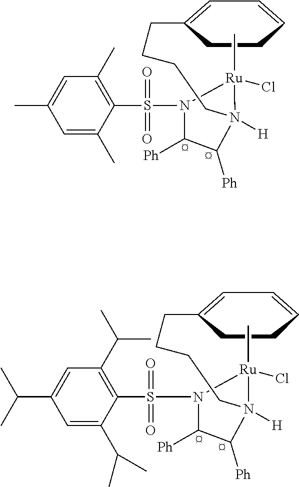

The metal complexes of formula (VI) may be selected from the group consisting of:

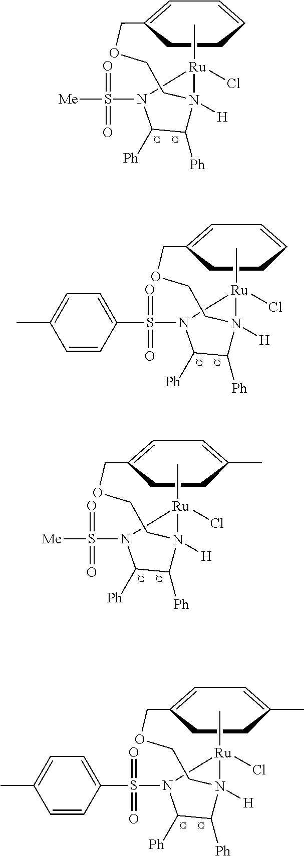

The preparation of the metal complexes of formula (VI) is given in WO2010/106364, WO2016/042298 and EP2609103.

The asymmetric transfer hydrogenation catalyst may be a complex of formula (IX):

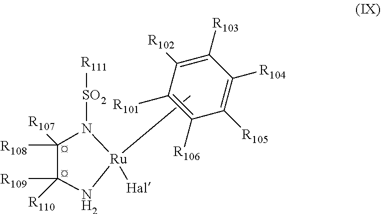

wherein,
R₁₀₁, R₁₀₂, R₁₀₃, R₁₀₄, R₁₀₅ and R₁₀₆ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, CN, —NR₂₀₀R₂₀₁, —COOH, COOR₂₀₀, —CONH₂, —CONR₂₀₀R₂₀₁ and —CF₃ wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₃₀₀R₃₀₁, —COOR₃₀₀, —CONR₃₀₀R₃₀₁ and —CF₃; and/or
R₁₀₁ and R₁₀₂, R₁₀₂ and R₁₀₃, R₁₀₃ and R₁₀₄, R₁₀₄ and R₁₀₅ or R₁₀₅ and R₁₀₆ together form an aromatic ring composed of 6 to 10 carbon atoms which is optionally substituted with one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃;
R₁₀₇, R₁₀₈, R₁₀₉ and R₁₁₀ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl and optionally substituted C₆₋₂₀ aryloxy wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃, or
R₁₀₇ and R₁₀₈ together with the carbon atom to which they are bound and/or R₁₀₉ and R₁₁₀ together with the carbon atom to which they are bound form an optionally substituted C₃₋₂₀ cycloalkyl or an optionally substituted O₂₋₂₀ cycloalkoxy, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃, or
one of R₁₀₇ and R₁₀₈ and one of R₁₀₉ and R₁₁₀ together form an optionally substituted C₅₋₁₀ cycloalkyl or an optionally substituted C₅₋₁₀ cycloalkoxy, wherein the substituents are independently selected from the group consisting of one or more straight C₁₋₂₀ alkyl, branched or cyclic O₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃,
provided R₁₀₇ and R₁₀₈ and/or R₁₀₉ and R₁₁₀ are not the same,
¤ represents an optically active carbon atom;
R₁₁₁ is an optionally substituted straight, branched or cyclic C₁₋₁₀ alkyl, an optionally substituted C₆₋₁₀ aryl or —NR₁₁₂R₁₁₃ wherein the substituents are selected from the group consisting of one or more straight, branched or cyclic C₁₋₁₀ alkyl, straight, branched or cyclic C₁₋₁₀ alkoxy, C₆₋₁₀ aryl, C₆₋₁₀ aryloxy, -Hal, —OH, —CN, —NR₂₀₀R₂₀₁, —COOR₂₀₀, —CONR₂₀₀R₂₀₁ and —CF₃;
R₁₁₂ and R₁₁₃ are independently selected from the group consisting of hydrogen, optionally substituted straight, branched or cyclic C₁₋₁₀ alkyl and optionally substituted C₆₋₁₀ aryl, wherein the substituents are selected from the group consisting of one or more straight, branched or cyclic C₁₋₁₀ alkyl groups, straight, branched or cyclic C₁₋₁₀ alkoxy, C₆₋₁₀ aryl, C₆₋₁₀ aryloxy, —OH, —CN, —NR₂₀₀R₂₀₁, —COOR₂₀₀, —CONR₂₀₀R₂₀₁ and —CF₃, or
R₁₁₂ and R₁₁₃ together with the nitrogen atom to which they are bound form an optionally substituted C₂₋₁₀ cycloalkyl-amino group, wherein the substituents are selected from the group consisting of one or more straight, branched or cyclic C₁₋₁₀ alkyl, straight, branched or cyclic C₁₋₁₀ alkoxy, C₆₋₁₀ aryl, C₆₋₁₀ aryloxy, —OH, —CN, —NR₂₀₀R₂₀₁, —COOR₂₀₀, —CONR₂₀₀R₂₀₁ and —CF₃;
R₂₀₀ and R₂₀₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN, —NR₃₀₀R₃₀₁, —COOR₃₀₀, —CONR₃₀₀R₃₀₁ and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
R₃₀₀ and R₃₀₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
and
Hal′ is a halogen.

The carbon atoms to which R₁₀₇ and R₁₀₈ and/or R₁₀₉ and R₁₁₀ are bound are asymmetric when R₁₀₇ and R₁₀₈ and/or R₁₀₉ and R₁₁₀ are not the same groups. In one embodiment, R₁₀₇ and R₁₀₈ are not the same groups. In another embodiment, R₁₀₈ and R₁₀₉ are not the same groups. The asymmetric carbon atoms are represented by the symbol “n”. The complex of formula (IX) therefore is chiral (optically active) and the transfer hydrogenation process of the invention is an asymmetric transfer hydrogenation process.

In one embodiment, R₁₀₁, R₁₀₂, R₁₀₃, R₁₀₄, R₁₀₅ and R₁₀₆ are each independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOH, COOR₂₀₀, —CONH₂, —CONR₂₀₀R₂₀₁ and —CF₃. In another embodiment, R₁₀₁, R₁₀₂, R₁₀₃, R₁₀₄, R₁₀₅ and R₁₀₆ are each independently selected from the group consisting of hydrogen, straight- or branched-chain C₁₋₁₀ alkyl, straight- or branched-chain C₁₋₁₀ alkoxy, C₆₋₁₀ aryl, C₆₋₁₀ aryloxy and —OH. For example, R₁₀₁, R₁₀₂, R₁₀₃, R₁₀₄, R₁₀₅ and R₁₀₆ may each independently selected from the group consisting of hydrogen, straight-chain C₁₋₁₀ alkyl and branched-chain C₁₋₁₀ alkyl. R₁₀₁, R₁₀₂, R₁₀₃, R₁₀₄, R₁₀₅ and R₁₀₆ may be each independently selected from the group consisting of hydrogen, methyl, ethyl, n-propyl, i-propyl, n-butyl, i-butyl, s-butyl and t-butyl. For example, R₁₀₁, R₁₀₂, R₁₀₃, R₁₀₄, R₁₀₅ and R₁₀₆ may each be hydrogen i.e. the aryl ring coordinated to the Ru atom is benzene. In another embodiment, R₁₀₂ may be methyl, R₁₀₅ may be i-propyl, and R₁₀₁, R₁₀₃, R₁₀₄ and R₁₀₆ may each be hydrogen i.e. the aryl ring coordinated to the Ru atom is p-cymene. In another embodiment, R₁₀₁, R₁₀₃ and R₁₀₅ are each methyl, and R₁₀₂, R₁₀₄ and R₁₀₆ are each hydrogen i.e. the aryl ring coordinated to the Ru atom is mesitylene.

In yet another embodiment, R₁₀₇, R₁₀₈, R₁₀₉ and R₁₁₀ are each independently selected from the group consisting of hydrogen, optionally substituted straight- or branched-chain C₁₋₁₀ alkyl, optionally substituted straight- or branched-chain C₁₋₁₀ alkoxy, optionally substituted C₆₋₁₀ aryl and optionally substituted C₆₋₁₀ aryloxy wherein the substituents are selected from the group consisting of straight- or branched-chain C₁₋₁₀ alkyl, straight- or branched-chain C₁₋₁₀ alkoxy, C₆₋₁₀ aryl, C₆₋₁₀ aryloxy and —OH.

The groups R₁₀₇, R₁₀₈, R₁₀₉ and R₁₁₀ may be each independently selected from the group consisting of hydrogen and optionally substituted C₆₋₁₀ aryl. For example, R₁₀₇, R₁₀₈, R₁₀₉ and R₁₁₀ may each be independently selected from the group consisting of hydrogen or phenyl. In one embodiment, one of R₁₀₇ and R₁₀₈ is phenyl and the other of R₁₀₇ and R₁₀₈ is hydrogen. In one embodiment, one of R₁₀₉ and R₁₁₀ is phenyl and the other of R₁₀₉ and R₁₁₀ is hydrogen.

In another embodiment, R₁₀₇ and R₁₀₈ together with the carbon atom to which they are bound and/or R₁₀₉ and R₁₁₀ together with the carbon atom to which they are bound form an optionally substituted C₅₋₁₀ cycloalkyl or an optionally substituted C₅₋₁₀ cycloalkoxy, wherein the substituents are selected from the group consisting of straight- or branched-chain C₁₋₁₀, straight- or branched-chain C₁₋₁₀ alkoxy, C₆₋₁₀ aryl, C₆₋₁₀ aryloxy and —OH.

In yet another embodiment, one of R₁₀₇ and R₁₀₈ and one of R₁₁₀₉ and R₁₁₀ together form an optionally substituted C₅₋₁₀ cycloalkyl or an optionally substituted C₅₋₁₀ cycloalkoxy, wherein the substituents are selected from the group consisting of straight- or branched-chain C₁₋₁₀ alkyl, straight- or branched-chain C₁₋₁₀ alkoxy, C₆₋₁₀ aryl, C₆₋₁₀ aryloxy and —OH.

In yet another embodiment, R₁₁₁ is an optionally substituted straight, branched or cyclic C₁₋₁₀ alkyl, an optionally substituted C₆₋₁₀ aryl wherein the substituents are selected from the group consisting of one or more straight, branched or cyclic C₁₋₁₀ alkyl, straight, branched or cyclic C₁₋₁₀ alkoxy, C₆₋₁₀ aryl, C₆₋₁₀ aryloxy, -Hal, —OH, —CN, —NR₂₀₀R₂₀₁, —COOR₂₀₀, —CONR₂₀₀R₂₀₁ and —CF₃. In another embodiment, the substituents are selected from the group consisting of one or more straight, branched or cyclic C₁₋₁₀ alkyl, straight, branched or cyclic C₁₋₁₀ alkoxy, C₆₋₁₀ aryl, C₆₋₁₀ aryloxy, -Hal, or —CF₃. In another embodiment, R₁₁₁ is a straight- or branched-chain C₁₋₁₀ alkyl or a C₆₋₁₀ aryl optionally substituted with one or more straight- or branched-chain C₁₋₁₀ alkyl groups. Examples of R₁₁₁ include, but are not limited to, p-tolyl, methyl, p-methoxyphenyl, p-chlorophenyl, trifluoromethyl, 3,5-dimethylphenyl, 2,4,6-trimethylphenyl, 2,4,6-triisopropylphenyl, 4-tert-butylphenyl, pentamethylphenyl and 2-naphthyl. R₁₁₁ may be methyl or a tolyl group.

In another embodiment, R₁₁₁ is —NR₁₁₂R₁₁₃ wherein R₁₁₂ and R₁₁₃ are independently selected from the group consisting of straight- or branched-chain C₁₋₁₀ alkyl and C₆₋₁₀ aryl optionally substituted with one or more straight- or branched-chain C₁₋₁₀ alkyl groups. —NR₁₁₂R₁₁₃ may be —NMe₂.

In yet another embodiment, R₁₁₂ and R₁₁₃ together with the nitrogen atom to which they are bound form an optionally substituted C₅₋₁₀ cycloalkyl-amino group wherein the substituents are selected from the group consisting of straight- or branched-chain C₁₋₁₀ alkyl, straight- or branched-chain C₁₋₁₀ alkoxy, C₆₋₁₀ aryl, C₆₋₁₀ aryloxy and —OH.

Hal′ may be chlorine, bromine or iodine, for example, chlorine.

The metal complexes of formula (IX) may be selected from the group consisting of:

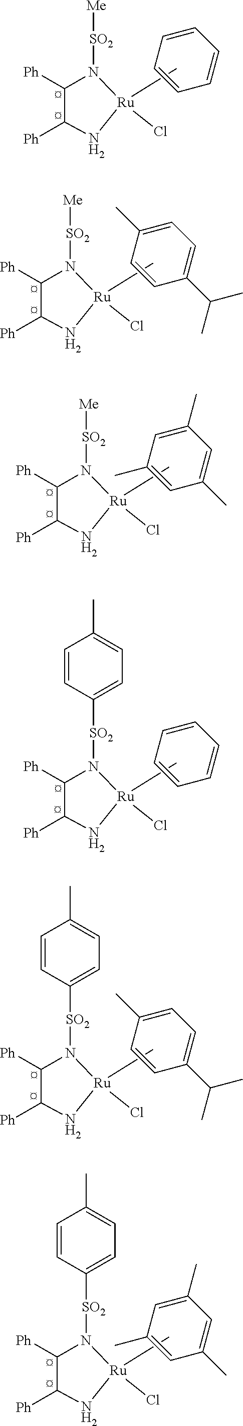

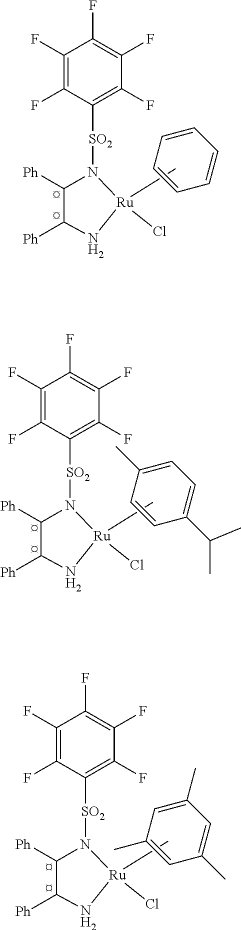

The preparation of the metal complexes of formula (IX) is given in EP0916637B (to Takasago International Corporation and others).

Asymmetric Transfer Hydrogenation Reaction

Transfer hydrogenation is the addition of hydrogen to a molecule from a source other than hydrogen gas. An asymmetric transfer hydrogen reaction reduces a prochiral molecule (such as the metallocenyl compound of formula (V)) to an optically active product (such as the metallocenyl compound of formula (IV)).

In the present invention, the ATH reaction is carried out in an aqueous solvent in the presence of an ATH catalyst and activated formic acid.

The ATH catalyst and activated formic acid are combined in the aqueous solvent. In one embodiment, the aqueous solvent is water. Water may be introduced to the ATH reaction in its own right or as part of the activated formic acid mixture. In another embodiment, the aqueous solvent is water and at least one water-miscible solvent. Any suitable water-miscible solvent may be used which is capable of dissolving the ATH catalyst and activated formic acid, and does not adversely affect either the chemical conversion of compound (V) to compound (IV) and/or enantiomeric purity of compound (IV)). When the ATH catalyst is a complex of formula (VI), the aqueous solvent may be selected from the group consisting of water, amide solvents, cyclic ether solvents and ester solvents. Examples of amide solvents include but are not limited to dimethylformamide (DMF) and dimethylacetamide (DMA). Examples of cyclic ether solvents include but are not limited to tetrahydrofuran (THF) and 1,4-dioxane. Mixtures of water and water-miscible solvents include but are not limited to water and THF, water and 1,4-dioxane, water and DMF, or water and DMA. Certain ester solvents are water-soluble in small quantities. These ester solvents include but are not limited to ethyl acetate and propyl acetate (i- or n-).

The ATH reaction may be monophasic (i.e. homogeneous) or biphasic. The ATH reaction may be biphasic if the aqueous phase contains measurable amounts of organic solvents dissolved.

The ATH reaction may be carried out at a temperature greater than 60° C. and below the boiling point of the reaction mixture. The boiling point of the reaction mixture may vary depending on the aqueous solvents used. In one embodiment, the ATH reaction is carried out at one or more temperatures in the range of >about 60° C. to about ≤about 100° C. In some embodiments, the hydrogenation is carried out at one or more temperatures ≥about 65° C. In some embodiments, the hydrogenation is carried out at one or more temperatures ≥about 70° C. In some embodiments, the hydrogenation is carried out at one or more temperatures ≥about 75° C. In some embodiments, the hydrogenation is carried out at one or more temperatures ≤about 95° C. In some embodiments, the hydrogenation is carried out at one or more temperatures ≤about 90° C. In some embodiments, the hydrogenation is carried out at one or more temperatures ≤about 85° C. In one preferred embodiment, the hydrogenation is carried out at one or more temperatures in the range of ≥about 77° C. to about ≤85° C., such as about 80° C.

The hydrogen donor in the ATH reaction is activated formic acid. “Activated formic acid” refers to a mixture of formic acid, a tertiary amine base and optionally water which forms a liquid reducing agent for an ATH reaction. When water is added to the ATH reaction as an individual component of the reaction, the activated formic acid may be a mixture of formic acid and a tertiary organic base. Alternatively, or in addition, the activated formic acid may be a mixture of formic acid, tertiary amine base and water. In this instance, it may not be necessary to add further water to the reaction mixture as an individual component. The tertiary amine base includes but is not limited to NR′R″R′″ wherein R′, R″, and R′″ are independently substituted or unsubstituted C₁₋₂₀-alkyl groups. Tertiary amines include but are not limited to trimethylamine and triethylamine, for example, triethylamine. In one embodiment, the activated formic acid is a mixture of concentrated formic acid, triethylamine and water. The activated formic acid may be deoxygenated before use e.g. by bubbling an inert gas, such as argon or nitrogen, through the liquid.

The molar ratio of formic acid:tertiary amine may be in the range of about 1:1 to about 1.5:1 moles i.e. the formic acid may be in slight excess. In one embodiment, the molar ratio of formic acid:tertiary amine is about 1:1 moles. In another embodiment, the molar ratio of formic acid:tertiary amine is about 1.1:1 moles. In yet another embodiment, the molar ratio of formic acid:tertiary amine is about 1.2:1 moles. In yet another embodiment, the molar ratio of formic acid:tertiary amine is about 1.4:1 moles.

When the formic acid:tertiary amine liquid is diluted with water, the concentration of formic acid:tertiary amine may be in the range of 1 M:1 M to about 1.2 M:1 M. In one embodiment, the molar ratio is about 1 M:1 M. In another embodiment, the molar ratio is about 1.1 M:1M. In yet another embodiment, the molar ratio is about 1.2 M:1M.

When the molar ratio of formic acid:tertiary amine in water is in the range of about 1 M:1 M to about 1.2 M:1 M, the pH of the liquid will in the range of about 4 to about 10. It has been found that slight variations in the concentration of formic acid:tertiary amine results in a major change in pH. In one embodiment, the pH of formic acid:triethylamine 1M:1M in water is about pH 6.5.

In certain embodiments, the activated formic acid is not an azeotropic mixture of formic acid and triethylamine i.e. formic acid:triethylamine in a ratio of 5 M:2 M.

The molar ratio of activated formic acid per carbonyl group to be reduced (i.e. —COR^{a} or —COR^{d}) may be in the range of about 1:1 to about 1.5:1 moles i.e. the activated formic acid may be in slight excess.

In one embodiment, the molar ratio of activated formic acid per carbonyl group to be reduced is about 1:1 moles. In another embodiment, the molar ratio of activated formic acid per carbonyl group to be reduced is about 1.1:1 moles. In yet another embodiment, the molar ratio of activated formic acid per carbonyl group to be reduced is about 1.2:1 moles. In yet another embodiment, the molar ratio of activated formic acid per carbonyl group to be reduced is about 1.4:1 moles.

The substrate/catalyst (S/C) molar ratio of the metallocenyl compound of formula (V) to ATH catalyst may in the range of about 100:1 to about 2000:1. In some embodiments, the S/C molar ratio may be ≥about 150:1. In some embodiments, the S/C molar ratio may be ≥about 200:1. In some embodiments, the S/C molar ratio may be ≥about 250:1. In some embodiments, the S/C molar ratio may be ≥about 300:1. In some embodiments, the S/C molar ratio may be ≥about 350:1. In some embodiments, the S/C molar ratio may be ≥about 400:1. In some embodiments, the S/C molar ratio may be ≥about 450:1. In some embodiments, the S/C molar ratio may be ≥about 500:1. In some embodiments, the S/C molar ratio may be ≥about 550:1. In some embodiments, the S/C molar ratio may be ≥about 600:1. In some embodiments, the S/C molar ratio may be ≤about 2000:1. In some embodiments, the S/C molar ratio may be ≤about 1750:1. In some embodiments, the S/C molar ratio may be ≤about 1500:1. In some embodiments, the S/C molar ratio may be ≤about 1250:1. In some embodiments, the S/C molar ratio may be ≤about 1000:1. In some embodiments, the S/C molar ratio may be ≤about 750:1. In some embodiments, the S/C molar ratio may be ≤about 700:1. In one embodiment, the S/C molar ratio may be in the range of >600:1 to ≤about 700:1, such as about 620:1 or 645:1. It is believed that the synthesis of compound (IV) (e.g. chiral ferrocenyl ethanol) has not been previously described at S/C molar ratios of >100:1 or higher, in particular at high S/C molar ratios of ≥600:1. The ability to perform the ATH reaction at high S/C molar ratios permits the development of a commercially-viable industrial process for the preparation of compounds (IV).

The ATH reaction may be conducted under an inert atmosphere, such as nitrogen or argon. In this instance, it is desirable for the reaction to be run in an open system, e.g. using a bubbler, to release the CO₂ by-product. The inert gas purges the CO₂ out of the reaction.

The ATH reaction is carried out for a period of time until it is determined that the reaction is complete. Completion of the reaction may be determined by in-process analysis e.g. by taking a sample of the reaction mixture and analysing it by HPLC to determine conversion and enantiomeric excess. In certain embodiments, the conversion of compound (V) to compound (IV) is >about 50%. In certain embodiments, the conversion is ≥about 60%. In certain embodiments, the conversion is ≥about 70%. In certain embodiments, the conversion is ≥about 80%. In certain embodiments, the conversion is ≥about 85%. In certain embodiments, the conversion is ≥about 90%. In certain embodiments, the conversion is ≥about 95%. In certain embodiments, the conversion is ≥about 97%. In certain embodiments, the conversion is substantially 100%. Typically, the reaction is complete within about 48 hours. The enantiomeric excess of compound (B) may be ≥90% ee, ≥91% ee, ≥92% ee, ≥93% ee, ≥94% ee, ≥95% ee, ≥96% ee, ≥97% ee, ≥98% ee, ≥99% ee or higher.

The reagents may be added in any suitable order. In this respect, a reactor may be charged with the compound (V), followed by the activated formic acid and ATH catalyst. The activated formic acid may be added in one portion. Alternatively, the activated formic acid may be added slowly and continuously over a period of time (e.g. using a syringe pump) and/or portionwise during the course of the reaction. As the ATH reaction produces 1 mole of CO₂ per 1 mole of reduced carbonyl, a significant amount of gas is released. As such, the slow/continuous and/or portionwise addition of the activated formic acid helps control the build-up of gas by limiting the amount of reducing agent present in the reactor vessel. The ATH catalyst may be added to the reaction mixture as a solid or as a solution in one of the water-miscible solvent described above (e.g. THF). The reaction mixture may be stirred for a suitable period of time and at a suitable temperature.

On completion of the reaction, the reaction vessel may be cooled to ambient temperature and optionally purged with one or more inert gas/vacuum cycles (e.g. one, two, three, four or five cycles) to remove excess carbon dioxide. The reaction mixture may be treated with an ester solvent (such as ethyl acetate), washed one or more times (e.g. one, two, three or more times) with water or brine, dried (e.g. over magnesium sulfate), and filtered (e.g. through a pad of silica and magnesium sulfate). The product, the compound (IV), may be obtained by the removal of the organic solvents, such as by increasing the temperature or reducing the pressure using distillation or stripping methods well known in the art.

The compound (IV) may be further treated with a hot alkane solvent (such as pentane, hexane or heptane) which causes the compound (IV) to precipitate or crystallise. The solid compound (IV) may then be washed with further alkane solvent and dried. Drying may be performed using known methods, for example, at temperatures in the range of about 10-60° C., such as 20-40° C., under 0.1-30 mbar for about 1 hour to about 5 days.

The isolated yield of compound (IV) may be ≥70%, ≥71%, ≥72%, ≥73%, ≥74%, ≥75% or higher. In certain embodiments, the isolated yield of compound (B) is ≥76%. In certain embodiments, the isolated yield of compound (IV) is ≥80%. In certain embodiments, the isolated yield of compound (IV) is ≥83%. In certain embodiments, the isolated yield of compound (IV) is ≥85%. In certain embodiments, the isolated yield of compound (IV) is ≥90%.

The compounds (IV) prepared by the process of the present invention are pure. In certain embodiments, the chemical purity of the compound (IV) is ≥90%, ≥91%, ≥92%, ≥93%, ≥94%, ≥95% or higher. In certain embodiments, the chemical purity of the compound (IV) is ≥95%. In certain embodiments, the chemical purity of the compound (IV) is ≥96%. In certain embodiments, the chemical purity of the compound (IV) is ≥97%. In certain embodiments, the chemical purity of the compound (IV) is ≥98%. In certain embodiments, the chemical purity of the compound (IV) is ≥99%.

The enantiomeric excess of isolated compound (IV) may be ≥90% ee, ≥91% ee, ≥92% ee, ≥93% ee, ≥94% ee, ≥95% ee, ≥96% ee, ≥97% ee, ≥98% ee, ≥99% ee or higher.

Compounds of formula (V) are obtainable for example by the method described by Gokel et al (J. Chem. Ed. 1972, 49, 4, 294).

Conversion of the Metallocenyl Alcohol of Formula (IV) to Ligands Useful in Asymmetric Catalysis

The metallocenyl alcohols of formulae (IV) are key intermediates in the preparation of various chiral metallocenyl ligands by methods known in the art (see, for example, Schaarschmidt and Lang, Organometallics, 2013, 32, 5668-5704).

For example, the metallocenyl alcohol of formula (IV) may transformed to Bophoz ligands or Josiphos ligands. In this instance, M is Fe, and m is 0, 1, 2 or 3 (but not 4), and at least one of the carbon atoms ortho to the —R^{a}C*H(OH) group must be unsubstituted (i.e. —H). At least one of carbon atoms ortho to the —R^{a}C*H(OH) group must be unsubstituted (i.e. —H) in order for a phosphorus-containing group to be chemically incorporated into the ferrocenyl compound by methods known in the art.

When the ligand is a Josiphos ligand, the ligand may be of formula (La) or (Lb):

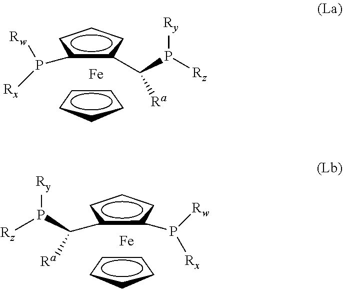

wherein,
R_{w} and Rₓ are independently selected from the group consisting of unsubstituted C₁₋₂₀-alkyl, substituted C₁₋₂₀-alkyl, unsubstituted C₃₋₂₀-cycloalkyl, substituted C₃₋₂₀-cycloalkyl, unsubstituted C₁₋₂₀-alkoxy, substituted C₁₋₂₀-alkoxy, unsubstituted C₅₋₂₀-aryl, substituted C₅₋₂₀-aryl, unsubstituted C₁₋₂₀-heteroalkyl, substituted C₁₋₂₀-heteroalkyl, unsubstituted C₂₋₂₀-heterocycloalkyl, substituted C₂₋₂₀-heterocycloalkyl, unsubstituted C₄₋₂₀-heteroaryl and substituted C₄₋₂₀-heteroaryl;
R_{y} and R_{z} are independently selected from the group consisting of unsubstituted C₁₋₂₀-alkyl, substituted C₁₋₂₀-alkyl, unsubstituted C₃₋₂₀-cycloalkyl, substituted C₃₋₂₀-cycloalkyl, unsubstituted C₁₋₂₀-alkoxy, substituted C₁₋₂₀-alkoxy, unsubstituted C₅₋₂₀-aryl, substituted C₅₋₂₀-aryl, unsubstituted C₁₋₂₀-heteroalkyl, substituted C₁₋₂₀-heteroalkyl, unsubstituted C₂₋₂₀-heterocycloalkyl, substituted C₂₋₂₀-heterocycloalkyl, unsubstituted C₄₋₂₀-heteroaryl and substituted C₄₋₂₀-heteroaryl; and
R^{a} is as defined above.

In one embodiment, R^{a} is selected from the group consisting of unsubstituted C₁₋₂₀-alkyl and substituted C₁₋₂₀-alkyl. In one embodiment, R^{a} is an unsubstituted branched- or straight-chain alkyl groups such as methyl, ethyl, n-propyl, iso-propyl, n-butyl, iso-butyl, sec-butyl, tert-butyl, pentyl, hexyl, heptyl, octyl, nonyl, decyl, dodecyl or stearyl. Preferably, R^{a} is methyl.

In one embodiment, R_{w} and Rₓ are independently selected from the group consisting of substituted or unsubstituted branched- or straight-chain alkyl groups such as methyl, ethyl, n-propyl, iso-propyl, n-butyl, iso-butyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantly, aryl groups such as phenyl, naphthyl or anthracyl and heteroaryl groups such as furyl. In one embodiment, the alkyl groups may be optionally substituted with one or more substituents such as halide (—F, —Cl, —Br or —I) or alkoxy groups, e.g. methoxy, ethoxy or propoxy. The aryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino, C₃₋₁₀ heterocycloalkyl groups (such as morpholinyl and piperadinyl) or tri(halo)methyl (e.g. F₃C—). The heteroaryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino or tri(halo)methyl (e.g. F₃C—). Preferably, R_{w} and Rₓ are the same and are selected from the group consisting of tert-butyl, cyclohexyl, phenyl, 3,5-bis(trifluoromethyl)phenyl, 4-methoxy-3,5-dimethylphenyl, 4-trifluoromethylphenyl, 1-naphthyl, 3,5-xylyl, 2-methylphenyl and 2-furyl, most preferably tert-butyl, cyclohexyl, phenyl, 3,5-bis(trifluoromethyl)phenyl, 4-methoxy-3,5-dimethylphenyl, 4-trifluoromethylphenyl, 1-naphthyl and 2-furyl.

In one embodiment, R_{y} and R_{z} are independently selected from the group consisting of substituted or unsubstituted branched- or straight-chain alkyl groups such as methyl, ethyl, n-propyl, iso-propyl, n-butyl, iso-butyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantly, aryl groups such as phenyl, naphthyl or anthracyl and heteroaryl groups such as furyl. In one embodiment, the alkyl groups may be optionally substituted with one or more substituents such as halide (—F, —Cl, —Br or —I) or alkoxy groups, e.g. methoxy, ethoxy or propoxy. The aryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino, C₃₋₁₀ heterocycloalkyl groups (such as morpholinyl and piperadinyl) or tri(halo)methyl (e.g. F₃C—). The heteroaryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino or tri(halo)methyl (e.g. F₃C—). Preferably, R_{y} and R_{z} are the same and are selected from the group consisting of tert-butyl, cyclohexyl, phenyl, 3,5-bis(trifluoromethyl)phenyl, 4-methoxy-3,5-dimethylphenyl, 4-trifluoromethylphenyl, 1-naphthyl, 3,5-xylyl, 2-methylphenyl and 2-furyl, most preferably tert-butyl, cyclohexyl, phenyl, 3,5-xylyl and 2-methylphenyl.

In one embodiment, the ligand of formula (La) is selected from the group consisting of:
(R)-1-[(S)-2-(diphenylphosphino)ferrocenyl]ethyldicyclohexylphosphine,
(R)-1-[(S)-2-(diphenylphosphino)ferrocenyl]ethyldi-tert-butylphosphine,
(R)-1-[(S)-2-(dicyclohexylphosphino)ferrocenyl]ethyldicyclohexylphosphine,
(R)-1-[(S)-2-(dicyclohexylphosphino)ferrocenyl]ethyldiphenylphosphine,
(R)-1-[(S)-2-(diphenylphosphino)ferrocenyl]ethyldi-3,5-xylylphosphine,
(R)-1-[(S)-2-(di-3,5-bis(trifluoromethyl)phenylphosphino)ferrocenyl]ethyldicyclohexylphosphine,
(R)-1-[(S)-2-(di-4-methoxy-3,5-dimethylphenylphosphino)ferrocenyl]ethyldicyclohexylphosphine,
(R)-1-[(S)-2-(di-3,5-bis(trifluoromethyl)phenylphosphino)ferrocenyl]ethyldi-3,5-xylylphosphine,
(R)-1-[(S)-2-(dicyclohexylphosphino)ferrocenyl]ethyldi-tert-butylphosphine,
(R)-1-[(S)-2-(di-(4-trifluoromethyl)phenylphosphino)ferrocenyl]ethyldi-tert-butylphosphine,
(R)-1-[(S)-2-(di-4-methoxy-3,5-dimethylphenylphosphino)ferrocenyl]ethyldi-tert-butylphosphine,
(R)-1-[(S)-2-(di-2-furylphosphino)ferrocenyl]ethyldi-3,5-xylylphosphine,
(R)-1-[(S)-2-(di-2-furylphosphino)ferrocenyl]ethyldi-tert-butylphosphine,
(R)-1-[(S)-2-(di-1-naphthylphosphino)ferrocenyl]ethyldi-tert-butylphosphine,
(R)-1-[(S)-2-(di-1-naphthylphosphino)ferrocenyl]ethyldi-3,5-xylylphosphine,
(R)-1-[(S)-2-(di-4-methoxy-3,5-dimethylphenylphosphino)ferrocenyl]ethyldi-3,5-xylylphosphine,
(R)-1-[(S)-2-(di-4-methoxy-3,5-dimethylphenylphosphino)ferrocenyl]ethyldi-(2-methylphenyl)phosphine,
(R)-1-[(S)-2-(di-2-furylphosphino)ferrocenyl]ethyldi-(2-methylphenyl)phosphine,
(R)-1-[(S)-2-(di-tert-butylphosphino)ferrocenyl]ethyldiphenylphosphine,
(R)-1-[(S)-2-(di-tert-butylphosphino)ferrocenyl]ethyldi-(2-methylphenyl)phosphine,
(R)-1-[(S)-2-(diphenylphosphino)ferrocenyl]ethyldiphenylphosphine,
(R)-1-[(S)-2-(diphenylphosphino)ferrocenyl]ethyldi(adamantyl)phosphine, and
(R)-1-[(S)-2-(di(adamantyl)phosphino)ferrocenyl]ethyldiphenylphosphine.

In one embodiment, the ligand of formula (Lb) is selected from the group consisting of:
(S)-1-[(R)-2-di(phenylphosphino)ferrocenyl]ethyldicyclohexylphosphine,
(S)-1-[(R)-2-di(phenylphosphino)ferrocenyl]ethyldi-tert-butylphosphine,
(S)-1-[(R)-2-di(cyclohexylphosphino)ferrocenyl]ethyldicyclohexylphosphine,
(S)-1-[(R)-2-di(cyclohexylphosphino)ferrocenyl]ethyldiphenylphosphine,
(S)-1-[(R)-2-di(phenylphosphino)ferrocenyl]ethyldi-3,5-xylylphosphine,
(S)-1-[(R)-2-di-(3,5-bis(trifluoromethyl)phenylphosphino)ferrocenyl]ethyldicyclohexylphosphine,
(S)-1-[(R)-2-di-(4-methoxy-3,5-dimethyl)phenylphosphino)ferrocenyl]ethyldicyclohexylphosphine,
(S)-1-[(R)-2-di-(3,5-bis(trifluoromethyl)phenylphosphino)ferrocenyl]ethyldi-3,5-xylylphosphine,
(S)-1-[(R)-2-di(cyclohexylphosphino)ferrocenyl]ethyldi-tert-butylphosphine,
(S)-1-[(R)-2-di-((4-trifluoromethyl)phenylphosphino)ferrocenyl]ethyldi-tert-butylphosphine,
(S)-1-[(R)-2-di-(4-methoxy-3,5-dimethyl)phenylphosphino)ferrocenyl]ethyldi-tert-butylphosphine,
(S)-1-[(R)-2-di-(2-furyl)phosphino)ferrocenyl]ethyldi-3,5-xylylphosphine,
(S)-1-[(R)-2-di-(2-furyl)phosphino)ferrocenyl]ethyldi-tert-butylphosphine,
(S)-1-[(R)-2-di(1-naphthyl)phosphino)ferrocenyl]ethyldi-tert-butylphosphine,
(S)-1-[(R)-2-di(1-naphthyl)phosphino)ferrocenyl]ethyldi-3,5-xylylphosphine,
(S)-1-[(R)-2-di-(4-methoxy-3,5-dimethyl)phenylphosphino)ferrocenyl]ethyldi-3,5-xylylphosphine,
(S)-1-[(R)-2-di-(4-methoxy-3,5-dimethyl)phenylphosphino)ferrocenyl]ethyldi-(2-methylphenyl)phosphine,
(S)-1-[(R)-2-di-(2-furyl)phosphinoferrocenyl]ethyldi-(2-methylphenyl)phosphine,
(S)-1-[(R)-2-di(tert-butylphosphino)ferrocenyl]ethyldiphenylphosphine,
(S)-1-[(R)-2-di(tert-butylphosphino)ferrocenyl]ethyldi-(2-methylphenyl)phosphine,
(S)-1-[(R)-2-diphenylphosphinoferrocenyl]ethyldiphenylphosphine,
(S)-1-[(R)-2-(diphenylphosphino)ferrocenyl]ethyldi(adamantyl)phosphine, and
(S)-1-[(R)-2-(di(adamantyl)phosphino)ferrocenyl]ethyldiphenylphosphine.

When the ligand is a Bophoz ligand, the ligand may be of formula (Lc) or (Ld):

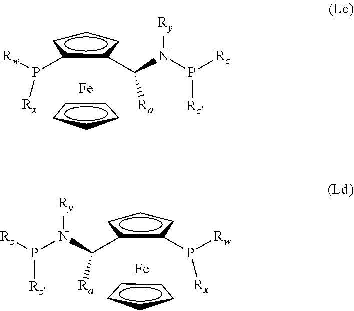

wherein,
R_{w} and Rₓ are independently selected from the group consisting of unsubstituted C₁₋₂₀-alkyl, substituted C₁₋₂₀-alkyl, unsubstituted C₃₋₂₀-cycloalkyl, substituted C₃₋₂₀-cycloalkyl, unsubstituted C₁₋₂₀-alkoxy, substituted C₁₋₂₀-alkoxy, unsubstituted C₅₋₂₀-aryl, substituted C₅₋₂₀-aryl, unsubstituted C₁₋₂₀-heteroalkyl, substituted C₁₋₂₀-heteroalkyl, unsubstituted C₂₋₂₀-heterocycloalkyl, substituted C₂₋₂₀-heterocycloalkyl, unsubstituted C₄₋₂₀-heteroaryl and substituted C₄₋₂₀-heteroaryl;
R_{y} is selected from the group consisting of unsubstituted C₁₋₂₀-alkyl, substituted C₁₋₂₀-alkyl, unsubstituted C₃₋₂₀-cycloalkyl, substituted C₃₋₂₀-cycloalkyl, unsubstituted C₁₋₂₀-alkoxy, substituted C₁₋₂₀-alkoxy, unsubstituted C₅₋₂₀-aryl, substituted C₅₋₂₀-aryl, unsubstituted C₁₋₂₀-heteroalkyl, substituted C₁₋₂₀-heteroalkyl, unsubstituted C₂₋₂₀-heterocycloalkyl, substituted C₂₋₂₀-heterocycloalkyl, unsubstituted C₄₋₂₀-heteroaryl and substituted C₄₋₂₀-heteroaryl;
R_{z} and R_{z′} are independently selected from the group consisting of unsubstituted C₁₋₂₀-alkyl, substituted C₁₋₂₀-alkyl, unsubstituted C₃₋₂₀-cycloalkyl, substituted C₃₋₂₀-cycloalkyl, unsubstituted C₁₋₂₀-alkoxy, substituted C₁₋₂₀-alkoxy, unsubstituted C₅₋₂₀-aryl, substituted C₅₋₂₀-aryl, unsubstituted C₁₋₂₀-heteroalkyl, substituted C₁₋₂₀-heteroalkyl, unsubstituted C₂₋₂₀-heterocycloalkyl, substituted C₂₋₂₀-heterocycloalkyl, unsubstituted C₄₋₂₀-heteroaryl and substituted C₄₋₂₀-heteroaryl; and
R^{a} is as defined above.

In one embodiment, R^{a} is selected from the group consisting of unsubstituted C₁₋₂₀-alkyl and substituted C₁₋₂₀-alkyl. In one embodiment, R^{a} is an unsubstituted branched- or straight-chain alkyl groups such as methyl, ethyl, n-propyl, iso-propyl, n-butyl, iso-butyl, sec-butyl, tert-butyl, pentyl, hexyl, heptyl, octyl, nonyl, decyl, dodecyl or stearyl. Preferably, R^{a} is methyl.

In one embodiment, R_{w} and Rₓ are independently selected from the group consisting of substituted or unsubstituted branched- or straight-chain alkyl groups such as methyl, ethyl, n-propyl, iso-propyl, n-butyl, iso-butyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantly, aryl groups such as phenyl, naphthyl or anthracyl and heteroaryl groups such as furyl. In one embodiment, the alkyl groups may be optionally substituted with one or more substituents such as halide (—F, —Cl, —Br or —I) or alkoxy groups, e.g. methoxy, ethoxy or propoxy. The aryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino, C₃₋₁₀ heterocycloalkyl groups (such as morpholinyl and piperadinyl) or tri(halo)methyl (e.g. F₃C—). The heteroaryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino or tri(halo)methyl (e.g. F₃C—). Preferably, R_{w} and Rₓ are the same and are selected from the group consisting of tert-butyl, cyclohexyl, phenyl, 3,5-bis(trifluoromethyl)phenyl, 4-methoxy-3,5-dimethylphenyl, 4-trifluoromethylphenyl, 1-naphthyl, 3,5-xylyl, 2-methylphenyl and 2-furyl, most preferably tert-butyl, cyclohexyl, phenyl, 3,5-bis(trifluoromethyl)phenyl, 4-methoxy-3,5-dimethylphenyl, 4-trifluoromethylphenyl, 1-naphthyl and 2-furyl.

In one embodiment, R_{y} is selected from the group consisting of substituted or unsubstituted branched- or straight-chain alkyl groups such as methyl, ethyl, n-propyl, iso-propyl, n-butyl, iso-butyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantly, aryl groups such as phenyl, naphthyl or anthracyl and heteroaryl groups such as furyl. In one embodiment, the alkyl groups may be optionally substituted with one or more substituents such as halide (—F, —Cl, —Br or —I) or alkoxy groups, e.g. methoxy, ethoxy or propoxy. The aryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino, C₃₋₁₀ heterocycloalkyl groups (such as morpholinyl and piperadinyl) or tri(halo)methyl (e.g. F₃C—). The heteroaryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino or tri(halo)methyl (e.g. F₃C—). R_{y} may be selected from the group consisting of methyl, tert-butyl, cyclohexyl, phenyl, 3,5-bis(trifluoromethyl)phenyl, 4-methoxy-3,5-dimethylphenyl, 4-trifluoromethylphenyl, 1-naphthyl, 3,5-xylyl, 2-methylphenyl and 2-furyl, most preferably, methyl, tert-butyl, cyclohexyl, phenyl, 3,5-xylyl and 2-methylphenyl.

In one embodiment, R_{z} and R_{z′} are independently selected from the group consisting of substituted or unsubstituted branched- or straight-chain alkyl groups such as methyl, ethyl, n-propyl, iso-propyl, n-butyl, iso-butyl, sec-butyl, tert-butyl, pentyl, hexyl, heptyl, octyl, nonyl, decyl, dodecyl or stearyl, cycloalkyl groups such as cyclopropyl, cyclobutyl, cyclopentyl, cyclohexyl or adamantly, aryl groups such as phenyl, naphthyl or anthracyl and heteroaryl groups such as furyl. In one embodiment, the alkyl groups may be optionally substituted with one or more substituents such as halide (—F, —Cl, —Br or —I) or alkoxy groups, e.g. methoxy, ethoxy or propoxy. The aryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino, C₃₋₁₀ heterocycloalkyl groups (such as morpholinyl and piperadinyl) or tri(halo)methyl (e.g. F₃C—). The heteroaryl group may be optionally substituted with one or more (e.g. 1, 2, 3, 4, or 5) substituents such as halide (—F, —Cl, —Br or —I), straight- or branched-chain C₁-C₁₀-alkyl (e.g. methyl), C₁-C₁₀ alkoxy, straight- or branched-chain C₁-C₁₀-(dialkyl)amino or tri(halo)methyl (e.g. F₃C—). Preferably, R_{z} and R_{z′} are the same and are selected from the group consisting of tert-butyl, cyclohexyl, phenyl, 3,5-bis(trifluoromethyl)phenyl, 4-methoxy-3,5-dimethylphenyl, 4-trifluoromethylphenyl, 1-naphthyl, 3,5-xylyl, 2-methylphenyl and 2-furyl, most preferably tert-butyl, cyclohexyl, phenyl, 3,5-xylyl and 2-methylphenyl.

In one embodiment, the ligand (Lc) may be (R)-Me-Bophoz.

In one embodiment, the ligand (Ld) may be (S)-Me-Bophoz.

The metallocenyl alcohol of formula (IV) where j=1 may be transformed into optically active metallocenyl ligands such as those described in U.S. Pat. No. 5,760,264 (to Lonza, AG). In this instance, M is Fe, Ru or Ni, m is 0, 1, 2 or 3 (but not 4) and n is 0, 1, 2, or 3 (but not 4), and at least one of the carbon atoms ortho to each of the —R^{a}C*H(OH) and —R^{d}C*H(OH) groups must be unsubstituted (i.e. —H). At least one of carbon atoms ortho to the —R^{a}C*H(OH) and —R^{d}C*H(OH) groups must be unsubstituted (i.e. —H) in order for phosphorus-containing groups to be chemically incorporated into the metallocenyl compound.

Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be described by the way of the following non-limiting Examples.

### EXAMPLES

### Abbreviations

| | |
|---|---|
| DCM | dichloromethane |
| DMF | dimethylformamide |
| Et₃N | triethylamine |
| IPA | isopropanol |
| THF | tetrahydrofuran |
| MTBE | methyl t-butyl ether |
| DEA | diethylamine |
| DMAP | dimethylaminopyridine |
| En | ethylenediamine |
| eq. | equivalent |
| EtOAc | ethyl acetate |
| HOOH | formic acid |
| H | hour |
| L | Litre |
| MEK | 2-butanone |
| mL | millilitre |
| RT | Room Temperature |
| Ts = tosylate | 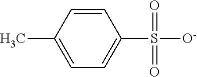 |
| Ms = mesylate | 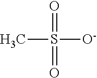 |
| [RuCl (R,R)-TsDPEN p-cymene] | 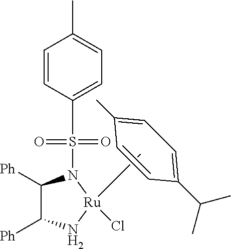 |
| [RuCl (R,R)-TsDPEN p-cymene] | 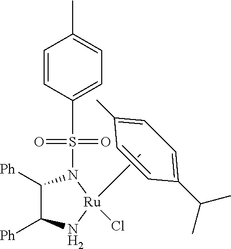 |

General

All reactions were carried out under argon or nitrogen atmosphere.

NMR measurements were recorded on Bruker AC 200 and Bruker Advance 400 spectrometers and the chemical shifts, in ppm, are relative to TMS for ¹H.

HPLC Chiral Method for Determining the Optical Purity of Metallocenyl Compound B:

AD-H column, 80:20 Heptane:EtOH+0.1% DEA, Flow: 1 ml/min, temp=25° C., detection at 254 nm. The peaks of the N,N-dimethyl-α-ferrocenylethylamine (B) enantiomers are baseline separated: (S)-enantiomer 4.4 min, (R)-enentiomer 3.8 min

HPLC Chiral Method for Metallocenyl Compounds of Formula (IV) and (V):

AS-H column, IPA/n-Heptane 30/70 with addition of small amounts of trifluoroacetic acid as modifier, Flow: 1 mL/min, detection at 205 nm. The peaks of the 1-Ferrocenyl Ethanol enantiomers are baseline separated: (S)-enantiomer 4.8 min, (R)-enentiomer 6.7 min.

The reaction sample was diluted with EtOAc to a concentration of 5 mg/1 mL. 1 mL of the resulting solution was further diluted with 4 mL of n-heptane and 2-5 μL of this solution was injected.

XRPD diffractograms were collected on a Bruker D8 diffractometer using Cu Kα radiation (40 kV, 40 mA) and a θ-2θ goniometer fitted with a Ge monochromator. The incident beam passes through a 2.0 mm divergence slit followed by a 0.2 mm anti-scatter slit and knife edge. The diffracted beam passes through an 8.0 mm receiving slit with 2.5° Soller slits followed by the Lynxeye Detector. The software used for data collection and analysis was Diffrac Plus XRD Commander and Diffrac Plus EVA, respectively. All data were processed within Diffrac Plus EVA using the Enhance background model; threshold=0.25, and the curvature varied to model baseline features sufficiently.

Samples were run under ambient conditions as flat plate specimens. The material was gently ground using pestle and mortar. The sample was prepared on a polished, zero-background (510) silicon wafer by gently packing the material into a cut cavity. The sample was rotated in its own plane.

The details of the standard collection method are:
Angular range: 4.5 to 42.0° 2θ
Step size: 0.01° 2θ
Collection time: 3.0 s/step (total collection time: 234 min)

### Example 1

Synthesis of Enantioenriched (R)—N,N-Dimethyl-α-Ferrocenylethyl Ammonium Dihydrogenphosphate (A*(H₂PO₄)) Starting from Enantioenriched Ferrocenylethanol (D) Using NaOAc.3H₂O as a Base

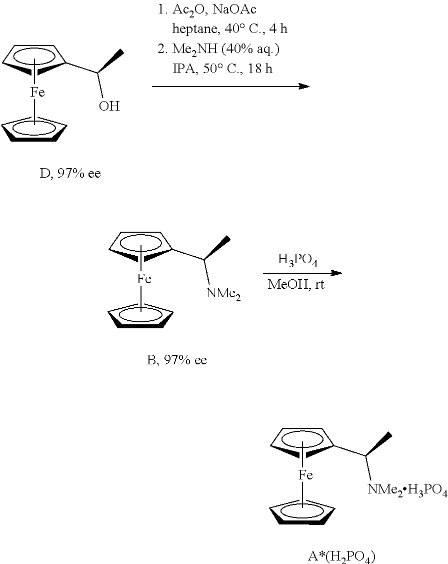

(R)-Ferrocenylethanol (D, 8.06 g, 35.06 mmol, 1 eq., 97% ee) and NaOAc-3H₂O (4.77 g, 35.06 mmol, 1 eq.) were placed into a 250 mL round bottom flask equipped with magnetic stirrer and heptane (34 mL) was added. Ac₂O (6.53 mL, 70.12 mmol, 2 eq.) was added in one portion at room temperature.

The mixture was stirred at 40° C. for 4 h.

The reaction mixture was cooled down to 0° C. and an aqueous solution of Me₂NH (40% aq., 22.08 mL, 5 eq.) was added dropwise followed by IPA (7 mL). The reaction was stirred overnight at 50° C. The organic phase was separated from the aqueous layer, concentrated by distillation and dried at 40° C./10 mbar.

The residue was dissolved in MeOH (30 mL) and H₃PO₄ (85% wt) (1.91 mL, 28.04 mmol, 0.8 eq.) was added dropwise at 0° C. The solution was stirred at room temperature for 1 h, concentrated in vacuum and acetone was added as anti-solvent to give a yellow-orange crystalline powder (10.6 g, 86% yield) that was collected by filtration.

¹H-NMR (A*(H₂PO₄)): ¹H NMR (400 MHz, CD₃OD): δ=1.81 (3H, d, J=6.72 Hz), 2.59 (6H, s), 4.26 (5H, s), 4.32-4.58 (5H, m).

TABLE
XRPD peak listing for A*(H₂PO₄).

| Angle (° 2θ) | Intensity (%) |
|---|---|
| 8.9 | 2.9 |
| 9.2 | 5.3 |
| 13.1 | 3.8 |
| 13.8 | 4.9 |

| | | |
|---|---|---|
| 14.0 | (14.0) | 15.4 |
| 14.2 | (14.25) | 23.7 |

| | |
|---|---|
| 14.4 | 8.0 |
| 14.9 | 10.3 |

| | | |
|---|---|---|
| 15.3 | (15.3) | 30.8 |

| | |
|---|---|
| 16.4 | 10.0 |
| 17.0 | 6.3 |
| 17.5 | 12.3 |

| | | |
|---|---|---|
| 17.9 | (17.95) | 100.0 |

| | |
|---|---|
| 18.2 | 10.4 |
| 18.4 | 7.0 |

| | | |
|---|---|---|
| 18.7 | (18.7) | 14.8 |

| | |
|---|---|
| 19.0 | 9.6 |
| 19.3 | 8.8 |
| 20.4 | 4.2 |
| 21.5 | 4.3 |

| | | |
|---|---|---|
| 22.0 | (22.04) | 13.9 |

| | |
|---|---|
| 22.5 | 5.9 |
| 22.7 | 7.5 |
| 22.8 | 6.3 |
| 23.8 | 8.0 |
| 24.0 | 8.3 |
| 24.6 | 5.1 |
| 25.0 | 6.1 |
| 25.2 | 8.3 |
| 28.2 | 4.8 |

Data in brackets are from a calculation using the single X-ray structure analysis data.

A single X-ray structure analysis confirms the identity of A(H₂PO₄). The calculated XPRD peak list is in high agreement with the measured XPRD peaklist reported above.

Thermal analysis (DSC, TGA) give an onset of decomposition of 125° C.

Recovery of the Free N, N-Dimethyl-α-Ferrocenylethylamine (B, Ugi Amine). Enantiomeric Excess Determination

Phosphate salt A*(H₂PO₄) (8.70 g, 24.5 mmol) was placed into a 50 mL round bottom flask and toluene (15 mL) was added. Then, NaOH (2M) was added to the suspension until pH 10-11 was reached. The organic phase was separated from the aqueous layer. After distillation of solvent compound N,N-dimethyl-α-ferrocenylethylamine (B) was obtained as a yellow-orange liquid (6.11 g, 97% yield). (R)-B: 97.2% ee by HPLC.

### Example 2

Synthesis of Enantioenriched (R)—N,N-Dimethyl-α-Ferrocenylethyl Ammonium Dihydrogenphosphate (A*(H₂PO₄)) Starting from Enantioenriched Ferrocenylethanol (D) Using NaOAc-3H₂O as a Base Followed by Purification

(R)—N,N-dimethyl-α-ferrocenylethyl ammonium dihydrogenphosphate (A*(H₂PO₄)) was obtained following the procedure of Example 1. The crude N,N-dimethyl-α-ferrocenylethyl ammonium dihydrogenphosphate (A*(H₂PO₄)) was slurried in DCM (50 mL). The slurry was stirred at room temperature for 30 min and then filtered to obtain compound A*(H₂PO₄) (8.58 g) in 68% yield.

After isolation of free N,N-dimethyl-α-ferrocenylethylamine (B, Ugi amine) following the procedure of example 1 a yellow-orange oil was obtained. Assayed as (R)-B of 97.2% ee by HPLC.

### Example 3

Synthesis of Enantioenriched (R)—N,N-Dimethyl-α-Ferrocenylethyl Ammonium Dihydrogenphosphate (A*(H₂PO₄)) Starting from Enantioenriched Ferrocenylethanol (D) Using NaOAc Anhydrous

(R)-Ferrocenylethanol (D, 1.21 g, 5.26 mmol, 1 eq., 97% ee) and NaOAc (432 mg, 5.26 mmol, 1 eq.) were placed into a 100 mL round bottom flask equipped with magnetic stirrer and heptane (5 mL) was added followed by the addition of Ac₂O (0.99 mL, 10.52 mmol, 2 eq.) at room temperature. The mixture was stirred at 40° C. for 4 h (a small sample from the reaction mixture was taken and analysed by ¹H-NMR showing only 15% conversion to product). Then, H₂O (0.30 mL, 16 mmol) was added and the reaction was stirred at 40° C. for 2 h more (¹H-NMR data shows 85% mol product).

The reaction mixture was cooled down to 0° C. and an aqueous solution of Me₂NH (40% aq., 3.31 mL, 5 eq.) was added dropwise followed by IPA (1 mL). The reaction was stirred overnight at 50° C. The organic phase was separated from the aqueous layer and distilled.

The residue was dissolved in MeOH (5 mL) and H₃PO₄ (85% wt) (0.25 mL, 4.33 mmol, 0.7 eq.) was added dropwise at 0° C. The solution was stirred at room temperature for 1 h, the solvent was distilled and the residue washed with acetone affording 1.36 g (73% yield) of the corresponding salt A*(H₂PO₄). After isolation of the N,N-dimethyl-α-ferrocenylethylamine (B) following the procedure of Example 1 a yellow-orange oil was obtained. (R)-B: 97.1% ee by HPLC.

### Example 4

Synthesis of enantioenriched di-(N,N-dimethyl-α-ferrocenylethylammonium) monohydrogenphosphate ((R)-A*2(HPO₄))

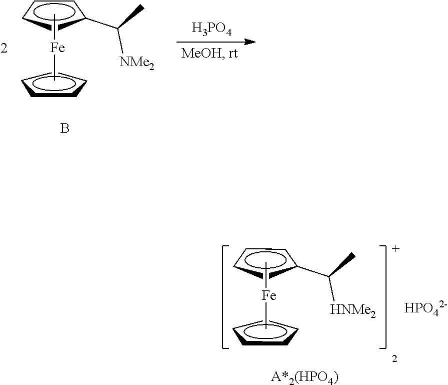

(R)—N,N-dimethyl-α-ferrocenylethyl amine (B, 7.20 g, 28 mmol, 97% ee) was dissolved in MeOH (25 mL) and H₃PO₄ (85% wt) (0.95 mL, 14 mmol) was added dropwise at 0° C. The solution was stirred at room temperature for 1 h, concentrated in vacuum and salt (R)-A*2(HPO₄) was precipitated by adding acetone as anti-solvent affording a yellow-orange crystalline powder (5.90 g, 70% yield) that was collected by filtration.

¹H-NMR ((R)-A*2(HPO₄)): ¹H NMR (400 MHz CD₃OD): δ 1.66 (3H, d, J=6.88 Hz), 2.35 (6H, s), 4.07 (1H, q, J=6.84 Hz), 4.19 (5H, s), 4.25-4.38 (4H, m).

TABLE
XRPD peak listing for ((R)-A*₂(HPO₄)).

| Angle (° 2θ) | Intensity (%) |
|---|---|
| 5.6 | 3.0 |
| 6.0 | 4.0 |
| 8.9 | 2.5 |
| 9.2 | 5.1 |
| 11.9 | 3.4 |
| 14.0 | 12.0 |
| 14.2 | 16.3 |
| 14.4 | 5.8 |
| 14.9 | 9.5 |
| 15.3 | 27.2 |
| 16.4 | 9.8 |
| 17.0 | 7.6 |
| 17.5 | 14.0 |
| 17.9 | 100.0 |
| 17.9 | 76.6 |
| 18.2 | 13.0 |
| 18.4 | 5.7 |
| 18.7 | 10.3 |
| 19.0 | 9.8 |
| 19.3 | 15.5 |
| 22.0 | 24.5 |
| 22.5 | 8.8 |
| 22.7 | 5.4 |
| 22.8 | 5.2 |
| 23.7 | 5.5 |
| 24.0 | 25.4 |
| 25.0 | 11.9 |
| 25.2 | 9.1 |
| 28.1 | 4.1 |
| 32.6 | 10.7 |

Thermal analysis (DSC, TGA) give a melting point of 173° C. followed by decomposition at higher temperatures

### Example 5 (Comparative)

Synthesis of Racemic Di-(N,N-Dimethyl-α-Ferrocenylethylammonium) Monohydrogenphosphate (Rac-A₂(HPO₄))

rac-N,N-dimethyl-α-ferrocenylethyl amine (rac-B, 4.69 g, 18 mmol) was dissolved in MeOH (18 mL) and H₃PO₄ (85% wt) (0.61 mL, 9 mmol) was added dropwise at 0° C. The solution was stirred at room temperature for 1 h. In contrast to the salt obtained from 97% ee amine (R)-B, this time some solid precipitated and it was collected by filtration in vacuum (697 mg of a yellow-orange crystalline powder). All the volatiles from the mother liquors were removed under reduced pressure affording some more yellow-orange powder (4.42 g) (total amount: 5.11 g).

¹H-NMR (rac-A₂(HPO₄)): ¹H NMR (400 MHz CD₃OD): δ 1.78 (3H, d, J=6.76 Hz), 2.56 (6H, s), 4.24 (5H, s), 4.29-4.54 (5H, m).

TABLE
XRPD peak listing for ((rac)-A₂(HPO₄)).

| Angle (° 2θ) | Intensity (%) |
|---|---|
| 5.5 | 5.9 |
| 8.9 | 6.4 |
| 11.0 | 2.0 |
| 13.0 | 13.6 |
| 13.4 | 4.6 |
| 14.1 | 8.3 |
| 15.2 | 33.6 |
| 15.5 | 88.7 |
| 16.5 | 12.5 |
| 17.1 | 13.0 |
| 17.9 | 52.6 |
| 19.0 | 37.0 |
| 19.8 | 9.3 |
| 21.1 | 6.9 |
| 22.0 | 100.0 |
| 21.7 | 6.3 |
| 22.2 | 6.4 |
| 23.9 | 9.6 |
| 24.4 | 6.1 |
| 25.8 | 4.3 |
| 26.2 | 4.8 |
| 26.4 | 4.3 |
| 27.0 | 4.4 |
| 28.5 | 6.2 |
| 30.8 | 7.2 |
| 33.3 | 12.9 |

Thermal analysis (DSC, TGA) give an onset of decomposition of 160° C.

### Example 6

General Procedure for the Synthesis of Enantioenriched (R)—N,N-Dimethyl-α-Ferrocenylethyl Ammonium Salts (Compounds of Formula I, Table 1, Entries 3-9)

(R)—N,N-dimethyl-α-ferrocenylethylamine B (8.6 mL, 40.9 mmol) was dissolved in MeOH (20 mL) and cooled down to 0° C. The corresponding acid (40.9 mmol) was added slowly over the MeOH solution and the mixture was stirred at room temperature for 1 h. Then, the volume was reduced in half and the corresponding anti-solvent was added in order to precipitate the salt (Table 1, entries 1, 2 and 4-7) affording yellow to orange solids in 70-98% yields. Compounds in entries 3, 8 and 9 were obtained as brown ionic liquids after removal of the solvent under high vacuum.

TABLE 1
N,N-dimethyl-α-ferrocenylethyl ammonium salts:
recovery yields and precipitation conditions

| | | Acid | | | |
|---|---|---|---|---|---|
| | | (ratio | Yield | | Solvent/anti- |
| Entry | Compound | A*:acid) | (%) | Appearance | solvent |
| 1^{a} | N,N-dimethyl-α- | H₃PO₄ | 86% | Yellow- | MeOH/Acetone |
| | ferrocenylethylammonium | (1:1) | | orange solid | |
| | dihydrogenphosphate (A*(H₂PO₄)) | | | | |
| 2^{b} | Di-(N,N-dimethyl-α- | H₃PO₄ | 70% | Yellow solid | MeOH/Acetone |
| | ferrocenylethylammonium) | (2:1) | | | |
| | monohydrogenphosphate | | | | |
| | (A*₂(HPO₄)) | | | | |
| 3 | N,N-dimethyl-α- | AcOH | 99% | Brown liquid | — |
| | ferrocenylethylammonium acetate | (1:1) | | | |
| | (A*(acetate)) | | | | |
| 4 | N,N-dimethyl-α- | Fumaric | 98% | Yellow solid | MeOH/THF |
| | ferrocenylethylammonium | acid | | | |
| | fumarate (A*(fumarate)) | (1:1) | | | |
| 5 | N,N-dimethyl-α- | Adipic | 96% | Yellow solid | MeOH/THF |
| | ferrocenylethylammonium adipate | acid | | | |
| | (A*(adipate)) | (1:1) | | | |
| 6 | N,N-dimethyl-α- | Oxalic | 98% | Yellow solid | MeOH/THF |
| | ferrocenylethylammonium oxalate | acid | | | |
| | (A*(oxalate)) | (1:1) | | | |
| 7 | N,N-dimethyl-α- | Benzoic | 89% | Yellow solid | MeOH/MTBE |
| | ferrocenylethylammonium | acid | | | |
| | benzoate (A*(benzoate)) | (1:1) | | | |
| 8 | N,N-dimethyl-α- | Mesylic | 99% | Brown liquid | — |
| | ferrocenylethylammonium | acid | | | |
| | mesylate (A*(mesylate)) | (1:1) | | | |
| 9 | N,N-dimethyl-α- | Tosylic | 99% | Brown liquid | — |
| | ferrocenylethylammonium tosylate | acid | | | |
| | (A*(tosylate)) | (1:1) | | | |

^{a}according to Example 1;
^{b}according to Example 4
¹H-NMR data
A*(acetate) (entry 3): ¹H NMR (400 MHz, CDCl₃): δ 1.62 (3H, d, J = 6.92 Hz), 2.01 (3H, s), 2.29 (6H, s), 4.11 (1H, q, J = 6.83 Hz), 4.15 (5H, s), 4.15-4.19 (1H, q, J = 2.43 Hz), 4.19-4.30 (3H, m, J = 3.62 Hz).
A*(fumarate) (entry 4): ¹H NMR (400 MHz, CD₃OD): δ 1.77 (3H, d, J = 6.84 Hz), 2.61 (6H, s), 4.24 (5H, s), 4.31-4.52 (5H, m), 6.70 (2H, s).
A*(adipate) (entry 5): ¹H NMR (400 MHz, CD₃OD): δ 4.57-4.71 (4H, m), 1.78 (3H, d, J = 6.88 Hz), 2.28 (4H, m), 2.58 (6H, s), 4.26 (5H, s), 4.33-4.51 (5H, m).
A*(oxalate) (entry 6): ¹H NMR (400 MHz, CD₃OD): δ 1.79 (3H, d, J = 6.44 Hz), 2.64 (6H, s), 4.27 (5H, s), 4.32-4.57 (5H, m).
A*(benzoate) (entry 7): ¹H NMR (400 MHz, CDCl₃): δ 1.72 (3H, d, J = 6.92 Hz), 2.43 (6H, s), 4.16 (5H, s), 4.19-4.29 (3H, m), 4.30-4.40 (2H, m), 7.33-7.48 (3H, m), 8.04-8.13 (2H, m).
A*(mesylate) (entry 8): ¹H NMR (400 MHz, CD₃OD): δ 1.79 (3H, d, J = 6.88 Hz), 2.65 (3H, s), 2.66 (3H, s), 2.73 (3H, s), 4.28 (5H, s), 2.52-2.72 (5H, m).
A*(tosylate) (entry 9): ¹H NMR (400 MHz, CD₃OD): δ 1.78 (3H, d, J = 6.88 Hz), 2.39 (3H, s), 2.64 (3H, s), 2.65 (3H, s), 4.27 (5H, s), 4.36-4.55 (5H, m), 7.26 (2H), 7.73 (2H).

### Example 7

Process for Increasing the Optical Purity of N,N-Dimethyl-α-Ferrocenylethyl Amine B

N,N-dimethyl-α-ferrocenylethyl ammonium dihydrogenphosphate (A*(H₂PO₄)) (5-10 g scale) was placed into a 250 mL round bottom flask equipped with magnetic stirrer and it was heated in a solvent or solvent mixture for the time and the temperature shown in Table 2. Then, the slurry was filtered under vacuum affording a yellow powder.

After isolation of the N,N-dimethyl-α-ferrocenylethyl amine B (Ugi amine) following the procedure of examples 1 or 2 a yellow-orange oil was obtained. Assayed as (R)-B of final ee (%) as indicated in Table 2.

TABLE 2
Recrystallisation of N,N-dimethyl-α-ferrocenylethyl
ammonium dihydrogenphosphate A*(H₂PO₄) - solvent screening

| Entry | Solvent | C (g/mL) | T (ext.) | Time | Initial ee(%) | Final ee(%) | Yield |
|---|---|---|---|---|---|---|---|
| 1 | IPA | 0.15 | 82° C. | 2 h | 97.2% | 98.2% | 94% |
| 2 | EtOH | 0.30 | 68° C. | 72 h | 98.2% | 98.2% | 33% |
| 3 | EtOH | 0.10 | 65° C. | 24 h | 98.2% | 99.3% | 55% |
| 4 | IPA:MeOH(1%) | 0.05 | 82° C. | 24 h | 97.2% | 99.4% | 83% |

### Example 8

Synthesis of Enantioenriched (S)—N,N-Dimethyl-α-Ferrocenylethyl Ammonium Dihydrogenphosphate (A*(H₂PO₄)) Starting from Enantioenriched (S)-Ferrocenylethanol (D) Using NaOAc-3H₂O as a Base-Solvent Screening¹ ¹ M. M. Mojtahedi, S. Samadian, “Efficient and Rapid Solvent-Free Acetylation of Alcohols, Phenols and Thiols Using Catalytic Amounts of Sodium Acetate Trihydrate”, Journal of Chemistry, 2013, Hindawi Publishing Corporation.

(S)-1-Ferrocenylethanol (D, 1 g, 3.8 mmol, 97.0% ee), NaOAc-3H₂O (517 mg, 3.8 mmol, 1 equiv), Ac₂O (1.1 mL, 11.4 mmol, 3 equiv) and the corresponding solvent (Table 3) were introduced in a carousel screening reaction tube and the reaction mixture was stirred at 40° C. for 18 h. Then, a sample was taken in order to analyse the mixtures by ¹H-NMR.

TABLE 3
Solvent screening (conversions as determined by ¹H-NMR)

| | | | Conversion to |
|---|---|---|---|
| | | Concentration | Product C |
| Entry | Solvent | (g D/mL solvent) | (% mol) |
| 1 | Neat | 0.25^{a} | 98.3% |
| 2 | Toluene^{b} | 0.1 | 35% |
| 3 | EtOAc | 0.1 | 22% |
| 4 | MTBE | 0.1 | 19% |
| 5 | MeCN | 0.1 | 45% |
| 6 | Acetone | 0.1 | 15% |
| 7 | Heptane^{c} | 0.1 | 79% |
| 8 | Heptane^{c,d} | 0.25 | 85% |

^{a}Excess of Ac₂O was employed (4 mL, 12 equiv).
^{b}3 equiv. of NaOAc•3H₂O were added.
^{c}The acetate C was transformed into amine B in order to confirm that the enantiomeric excess of 97.0% ee was retained;
^{d}The reaction time was 2 h.

### Example 9

Synthesis of N,N-Dimethyl-α-Ferrocenylethyl Ammonium Dihydrogenphosphate (A*(H₂PO₄)) with Loss of Optical Purity Starting from Enantioenriched Ferrocenylethanol (D) Using AcOH/iPrOAc as Acetylating Agent (Comparative)

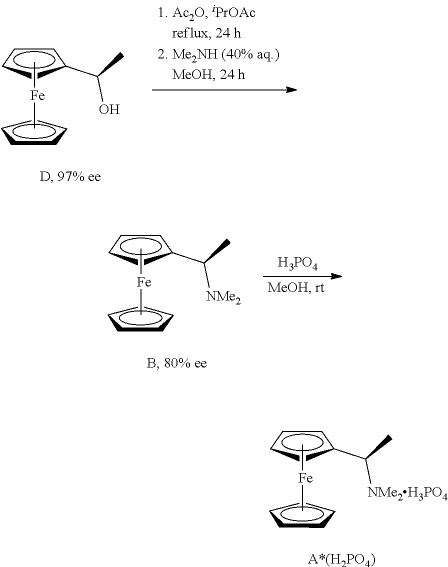

(R)-1-Ferrocenylethanol (D, 69.0 g, 0.30 mol, 97% ee) was dissolved in ⁱPrOAc (500 mL) and AcOH (20 mL) was added. The mixture was refluxed for 24 h using a Dean-Stark in order to remove generated H₂O from the reaction media (4.5 mL of H₂O were collected). Then, all the volatiles were distilled in vacuum adding small amounts of ⁱPrOAc to remove remaining AcOH and H₂O.

The residue was dissolved in MeOH (500 mL) and Me₂NH (40% aq., 163 mL) was added. The reaction was stirred at RT for 24 h. The mixture was concentrated in vacuo to remove a significant amount of unreacted Me₂NH affording a dark red oil.

The residue was dissolved in MeOH (500 mL) and H₃PO₄ (20.3 mL) was added dropwise. The mixture was allowed to stir at RT for 1 h. The solvent was removed in vacuo and toluene was employed in order to dry the residue (azeotropic distillation of remaining H₂O). The phosphate salt A*(H₂PO₄) was precipitated from MeOH/Acetone obtaining a yellow-orange solid (64 g, 0.18 mol, 63% yield).

After isolation of the corresponding amine B following the procedure of Example 1 a yellow-orange oil was obtained. Assayed as (R)-B of 80% ee by HPLC.

### Example 10

Synthesis of DMAP-H₃PO₄

DMAP (5.00 g mL, 40.9 mmol) was dissolved in MeOH (30 mL) and cooled down to 0° C. H₃PO₄ (85% wt.) (2.8 mL, 40.9 mmol) was added slowly over the MeOH solution and the mixture was stirred at room temperature for 1 h. Then, precipitate was filtered off and washed with MeOH affording DMAP.H₃PO₄ as a white solid (8.82 g, 98% yield).

### Example 11

Synthesis of DMAP-HOAc

DMAP (5.00 g mL, 40.9 mmol) was dissolved in MeOH (30 mL) and cooled down to 0° C. AcOH (2.35 mL, 40.9 mmol) was added slowly over the MeOH solution and the mixture was stirred at room temperature for 1 h. Then, the solvent was removed in vacuo and the residue was slurried in acetone and filtered off affording DMAP-HOAc as a white hygroscopic solid (6.78 g, 91% yield).

### Example 12

Solubility Comparison Between N,N-Dimethyl-α-Ferrocenylethyl Ammonium Dihydrogenphosphate (a*(H₂PO₄)), DMAP.H₃PO₄ and DMAP.HOAc

In cases where DMAP is used as catalyst for the acetylation of ferrocenylethanol (D), DMAP-containing impurities are carried over in the subsequent steps of the synthesis of N,N-dimethyl-α-ferrocenylethyl ammonium dihydrogenphosphate (A*(H₂PO₄)). Purification of the crude product mixture is, therefore required.

As shown in Table 4 the solubilities of the Ugi ammonium dihydrogen phosphate ((A*(H₂PO₄)), DMAP-H₃PO₄ and DMAP.HOAc are different in dichloromethane, methanol and acetonitrile.
a) In order to separate compounds A*(H₂PO₄) and DMAP.H₃PO₄, the sample is dissolved in MeOH and the solids filtered off to obtain A*(H₂PO₄) (potentially contaminated with DMAP.HOAc) after distillation of the mother liquor.
b) The removal of DMAP.HOAc can be achieved dissolving the material of step a) either in DCM or MeCN. The mixture is filtered in vacuo to afford A*(H₂PO₄) as a solid.

TABLE 4
Solubility comparison between (A*(H₂PO₄)), DMAP•H₃PO₄ and DMAP•HOAc in various
solvents

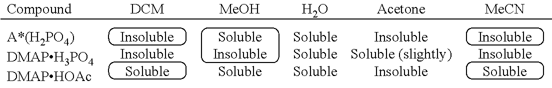

### Example 13

Preparation of HCOOH.Et₃N 2M:2M Mixture

The HCOOH.Et₃N 2M:2M mixture was prepared by dissolving HCOOH (400 mmol, 18.412 g, 15.7 mL of 96%) in water (10 mL) and neutralizing it with Et₃N (400 mL, 40.48 g, 56.02 mL). Finally, pH was adjusted to 6.5 using a calibrated pH meter and the volume was topped up with water to 200 mL. The obtained mixture was a viscous colourless liquid. The reagent was deoxygenated by bubbling Argon though the liquid for 30 min.

### Example 14

Small Scale Procedure 1: One Pot Reaction

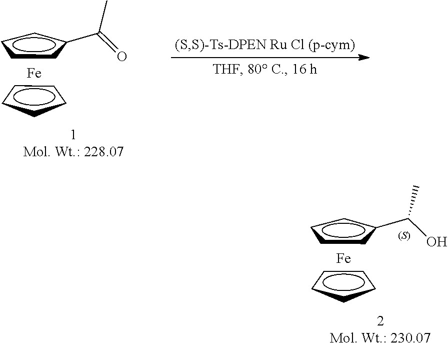

Ts-DPEN Ru Cl (p-cym) MW: 636.2

A 500 mL round bottom flask equipped with reflux condensed and large stirring bar was charged with acetyl ferrocene (51 g, 223 mmol) and placed under argon atmosphere by three vacuum/refill cycles. 130 mL of the solution of HCOOH.Et₃N (260 mmol, 1.2 eq.) of Example 13 was added, followed by a solution of [RuCl (S,S)-TsDPEN p-cymene (228 mg, 0.36 mmol, S/C 620/1) in THF (45 mL). The reaction mixture was heated to 80° C. for 16 h. After cooling, a sample was taken and analysed by HPLC to determine conversion and enantiomeric excess (95% conversion, 95% ee). The reaction mixture was diluted with EtOAc (200 mL) and transferred to 500 mL separating funnel. The organic phase was washed with brine. The aqueous phases were extracted back with EtOAc and the combined organic extracts were dried (MgSO₄) and filtered over glass sinter containing pad of silica gel (2 cm) and MgSO₄ (1 cm). Solvents were evaporated to give crude (S)-1-ferrocenyl ethanol as a red solid. This was crystallized from hot heptane (300 mL) to give orange to yellow crystalline material. This was collected by filtration, washed with cold heptane (50 mL), transferred to a round bottom flask and dried in vacuo to give (S)-1-ferrocenyl ethanol as a yellow solid (isolated yield: 37.9 g, 76% yield, 95% purity by ¹H NMR, 95% ee).

### Example 15

Large Scale Procedure 1: One Pot Reaction

The above procedure was repeated in a 20 L flask with an efficient reflux condenser connected to a silicon oil filled bubbler as a pressure reliever, using acetyl ferrocene (312 g, 1.368 mol), HCOOH.Et₃N (795 mL, 1.587 mol, 1.2 eq.), [RuCl (R,R)-TsDPEN p-cymene (1.4 g, 0.0022 mol, S/C 620/1), THF (275 mL). The reaction was heated to 80° C. for a total of 20 hours, until HPLC analysis showed only 1.6% starting material left. A vigorous evolution of gas was detected during the first two hours at 80° C. After work up (no filtration required to achieve phase separation) and recrystallization, (R)-1-ferrocenyl ethanol was obtained in 89% isolated yield (280 g, >99% purity by HPLC, >98% purity by ¹H NMR, 98.3% ee).

### Example 16

Small-Scale Procedure 2: Slow Addition of HCOOH.Et₃N

A 250 mL two neck round bottom flask equipped with reflux condensed and large stirring bar was charged with acetyl ferrocene (29.4 g, 129 mmol) and placed under argon atmosphere by three vacuum/refill cycles. A solution of HCOOH.Et₃N 2M:2M (25 mL, 50 mmol, 0.42 eq.) was added, followed by a solution of [RuCl (R,R)-TsDPEN p-cymene (127 mg, 0.2 mmol, S/C 645/1) in THF (26 mL). The reaction mixture was deoxygenated by three vacuum/refill cycles and heated up to 80° C. After 30 minutes, slow addition of reagent was commenced using a syringe pump. The remaining 50 mL of HCOOH.Et₃N 2M:2M (0.84 eq.) were added over 3 h. When the addition was completed, a sample of the reaction mixture was and analysed by HPLC to determine conversion and enantiomeric excess (68% conversion, 91% ee). Heating was continued overnight. In the morning, HPLC analysis showed 96% conversion and 95% enantiomeric excess.

### Example 17

Large-Scale Procedure 2: Slow Addition of HCOOH.Et₃N

The above procedure was repeated in the 20 L reactor of Example 15 using acetyl ferrocene (312 g, 1.368 mol), HCOOH.Et₃N 2M:2M (initial amount: 286 mL, 0.572 mol, 0.42 eq.), [RuCl (R,R)-TsDPEN p-cymene (1.4 g, 0.0022 mol, S/C 620/1) and THF (275 mL). HCOOH.Et₃N 2M:2M (574 mL, 0.148 mmol, 0.84 eq.) was added over six hours at 80° C. causing a steady evolution of gas from the reaction. The reaction was heated to 80° C. for a total over 16 hours (including addition time), until HPLC analysis showed only 1.4% starting material left. After work up and recrystallization, (R)-1-ferrocenyl ethanol was obtained in 83% isolated yield (261 g, >99% purity by HPLC, >99% purity by ¹H NMR, 97.4% ee).

### Example 18

Small-Scale Procedure 3: Slow Addition of HCOOH

A 500 mL two neck round bottom flask equipped with reflux condenser was charged with acetyl ferrocene (41.5 g, 181.5 mmol) and placed under argon atmosphere by three vacuum/refill cycles. A solution of HCOOH.Et₃N 2M:2M (36.4 mL 72.8 mmol, 0.33 eq.) was added, followed by a solution of [RuCl (R,R)-TsDPEN p-cymene] (192 mg, 0.302 mmol, S/C 600/1) in THF (25.7 mL). The reaction mixture was deoxygenated by three vacuum/refill cycles and heated to 80° C. After 30 minutes, slow addition of HCOOH was commenced using a syringe pump. HCOOH (5.46 mL, 145 mmol, 0.8 eq) was added over 4 hours. When the addition was completed, a sample of the reaction mixture was taken and analysed by HPLC to determine conversion and enantiomeric excess (83% conversion, 95% ee). Heating was continued overnight. In the morning, a sample of the reaction mixture was taken and analysed by HPLC to determine conversion and enantiomeric excess (96% conversion, 95% ee).

### Example 19

Large-Scale Procedure 3: Slow Addition of HCOOH.Et₃N

The above procedure was repeated in a 20 L flask using acetyl ferrocene (312 g, 1.368 mol), HCOOH.Et₃N 2M:2M (initial amount: 274 mL, 0.548 mol, 0.4 eq.), [RuCl (R,R)-TsDPEN p-cymene] (1.4 g, 0.0022 mol, S/C 620/1) and THF (193 mL). HCOOH (50 g, 1.086 mol, 0.8 eq.) was added over four hours at 80° C. causing a steady evolution of gas from the reaction. The reaction was heated to 80° C. for a total over 14 hours (including addition time), until HPLC analysis showed only 2.1% starting material left. After work up (filtration was required to achieve phase separation) and recrystallization, (R)-1-ferrocenyl ethanol was obtained in 90% isolated yield (282 g, >97% purity by HPLC, >99% purity by ¹H NMR, 98.3% ee).

1. A metallocenyl compound of formula (I), 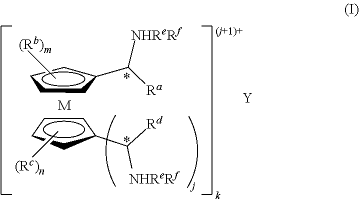
wherein:
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, and substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, and substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} or Z^{(j+1)k-};
Z is a non optically active anion; and
* denotes an optically active carbon atom.

2. The metallocenyl compound according to claim 1, wherein R^{a} is methyl.

3. The metallocenyl compound according to claim 1 wherein j is 0.

4. The metallocenyl compound according to claim 1, wherein m is 0.

5. The metallocenyl compound according claim 1, wherein n is 0.

6. The metallocenyl compound according to claim 1, wherein R^{a} is methyl and m, n and j are 0.

7. The metallocenyl compound according to claim 1, wherein j is 1.

8. The metallocenyl compound according to claim 1, wherein R^{d} is methyl.

9. The metallocenyl compound according to claim 1, wherein R^{e} and R^{f} are methyl.

10. The metallocenyl compound according to claim 1, wherein M is Fe, Ru or Os.

11. The metallocenyl compound according to claim 1, wherein Z is selected from the group consisting of a monoatomic anion, an oxyanion and an organic anion.

12. The metallocenyl compound according to claim 11, wherein the oxyanion is (H₂PO₄)⁻ or (HPO₄)²⁻.

13. The metallocenyl compound according to claim 11, wherein Z is a monoanion or a dianion.

14. A process for the preparation of a metallocenyl compound of formula (I): 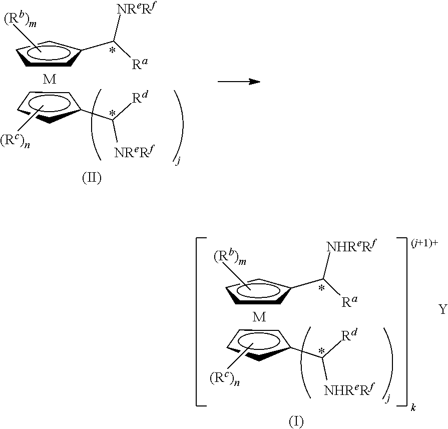
comprising mixing a compound of formula (II) with an acid Hₖ₍ⱼ₊₁₎Z in a solvent to form a compound of formula (I),
wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, and substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, and substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} or Z^{(j+1)k-}—;
Z is a non optically active anion; and
* denotes an optically active carbon atom.

15. The process according to claim 14, wherein Hₖ₍ⱼ₊₁₎Z is H₃PO₄, fumaric acid, adipic acid, oxalic acid, benzoic acid, acetic acid, methanesulfonic acid and p-toluenesulfonic acid.

16. The process according to claim 14, wherein the solvent is selected from the group consisting of an alcohol, an ether, an aromatic solvent, and an ester or a combination thereof.

17. The process according to claim 16, wherein the solvent is an alcohol.

18. The process according to claim 17, wherein the alcohol is methanol.

19. The process according to claim 14, further comprising obtaining the metallocenyl compound of formula (II) from the metallocenyl compound of formula (I) in the presence of a base.

20. A process for increasing the optical purity of a compound of formula (II), 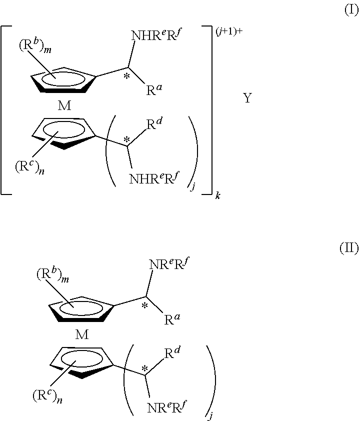
comprising the steps of:
a) mixing a metallocenyl compound of formula (I) with a solvent to obtain a suspension of solid particles in a liquid, wherein the mixing is carried out at about the boiling point of the solvent;
b) separating metallocenyl compound of formula (I) as a solid from the suspension of step a);
c) obtaining the compound of formula (II) from the metallocenyl compound of formula (I) of step b) in the presence of a base,
wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, and substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, and substituted C₅-C₂₀-aryl;
M is selected from the group consisting of Fe, Ru, Os and Ni;
m is an integer from 0 to 4;
j is 0 or 1; and
when j=0, n is an integer from 0 to 5 and k is 1 or 2;
when j=1, n is an integer from 0 to 4 and k is 1;
Y is (j+1) Z^{k-} or Z^{(j+1)k-}—;
Z is a non optically active anion; and
* denotes an optically active carbon atom.

21. The process according to claim 14, further comprising a process for increasing the optical purity of the compound of formula (II), 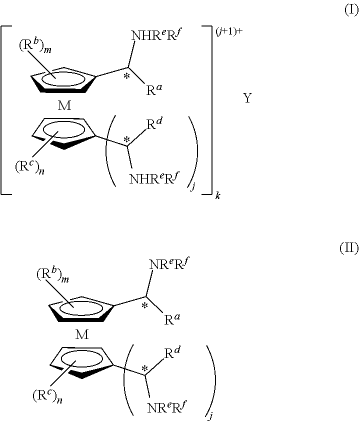
comprising the steps of:
a) mixing the metallocenyl compound of formula (I) with a solvent to obtain a suspension of solid particles in a liquid, wherein the mixing is carried out at about the boiling point of the solvent;
b) separating metallocenyl compound of formula (I) as a solid from the suspension of step a);
c) obtaining the compound of formula (II) from the metallocenyl compound of formula (I) of step b) in the presence of a base.

22. The process according to claim 20, wherein the compound of formula (I) is compound A*(H₂PO₄) and the compound of formula (II) is compound B:

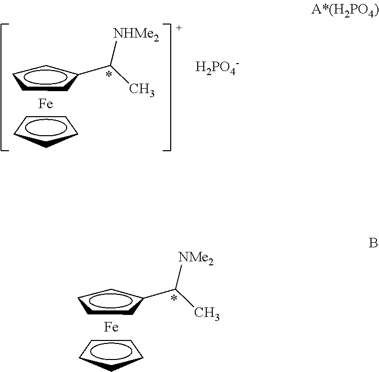

23. The process according to claim 20, wherein the solvent comprises an alcohol.

24. The process according to claim 23, wherein the alcohol is selected from the group consisting of methanol, n-propanol, and isopropanol or combinations thereof.

25. The process according to claim 20, wherein the base is sodium hydroxide.

26. The process according to claim 22, wherein the enantiomeric excess of compound B is ≥99% ee.

27. The process according to claim 14, wherein the compound of formula (II) is prepared by mixing a compound of formula (III) with a compound of formula HNR^{e}R^{f} in a solvent to form the compound of formula (II), 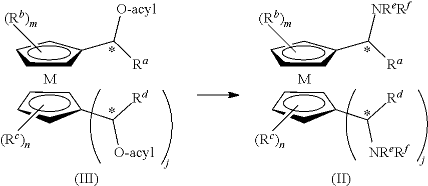
wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, and substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, and substituted C₅-C₂₀-aryl;
M is selected from the group consisting of Fe, Ru, Os and Ni;
m is an integer from 0 to 4;
j is 0 or 1; and
when j=0, n is an integer from 0 to 5;
when j=1, n is an integer from 0 to 4; and
* denotes an optically active carbon atom.

28. The process according to claim 27, wherein the solvent comprises a mixture of alcohol and a C₁-C₈ alkane.

29. The process according to claim 28, wherein the alcohol is a mixture of isopropanol and heptane or a mixture of isopropanol and cyclohexane.

30. The process according to claim 27, wherein the compound of formula (III) is prepared by mixing a compound of formula (IV) with a compound of formula acyl-LG in the presence of a base to form a compound of formula (III), wherein LG is a leaving group:

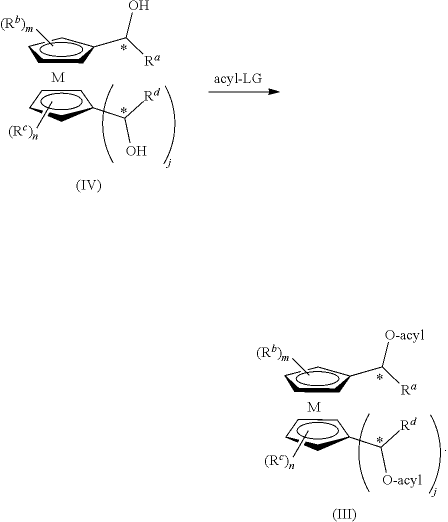

31. The process according to claim 30, wherein the compound of formula acyl-LG is a carboxylic anhydride or an acyl chloride.

32. The process according to claim 30, wherein the compound of formula acyl-LG is acetic anhydride.

33. The process according to claim 30, wherein the base is sodium acetate.

34. The process according to claim 33, wherein the sodium acetate is NaOAc.3H₂O.

35. The process according to claim 30, further comprising a solvent.

36. The process according to claim 35, wherein the solvent is an aprotic solvent.

37. The process according to claim 36, wherein the aprotic solvent is heptane.

38. The process according to claim 30, wherein the base is dimethylaminopyridine (DMAP).

39. The process according to claim 30, wherein the compound of formula (IV) is prepared by asymmetric transfer hydrogenation (ATH) of a metallocenyl compound of formula (V) 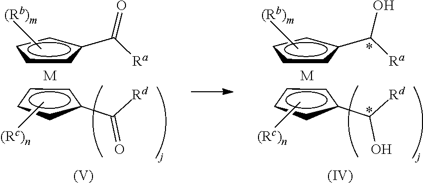
wherein:
the asymmetric transfer hydrogenation is carried out in an aqueous solvent at a temperature greater than 60° C. in the presence of an asymmetric transfer hydrogenation catalyst and activated formic acid; wherein
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, and substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, and substituted C₅-C₂₀-aryl;
M is selected from the group consisting of Fe, Ru, Os and Ni;
m is an integer from 0 to 4;
j is 0 or 1; and
when j=0, n is an integer from 0 to 5;
when j=1, n is an integer from 0 to 4; and
* denotes an optically active carbon atom.

40. The process according to claim 14, wherein the compound of formula (I) is compound A*(H₂PO₄), the compound of formula (II) is compound B, the compound of formula (III) is compound C, the compound of formula (IV) is compound D:

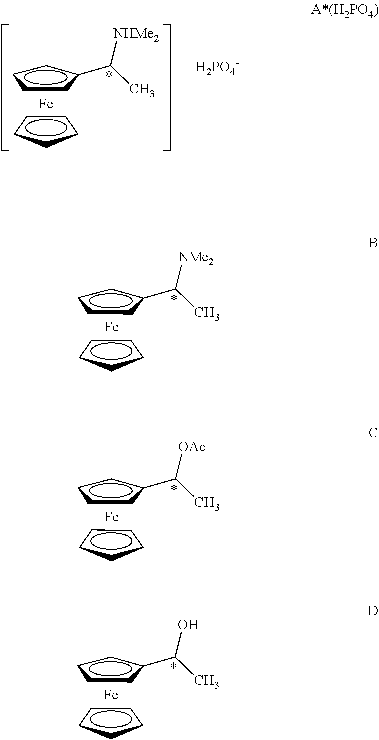

41. The process according to claim 38, further comprising the steps of:
a) adding methanol to a compound A*(H₂PO₄) containing DMAP-H₃PO₄ and DMAP-HOAc, to produce a solid-liquid mixture;
b) separating the liquid containing the compound A*(H₂PO₄) and DMAP-HOAc from the solid-liquid mixture of step a);
c) isolating the compound A*(H₂PO₄) containing DMAP-HOAc from the liquid of step b);
d) adding dichloromethane or acetonitrile to the isolated compound A*(H₂PO₄) containing DMAP-HOAc of step c), to produce a second solid-liquid mixture;
e) isolating the solid from the second solid-liquid mixture of step d) to produce a compound A*(H₂PO₄) of higher purity than before the steps a) to e).

42. The process according to claim 27, wherein the compound of formula (III) is obtained in situ before reaction with the compound of formula HNR^{e}R^{f}.

43. A process for the asymmetric transfer hydrogenation (ATH) of a metallocenyl compound of formula M to a metallocenyl compound of formula (IV), 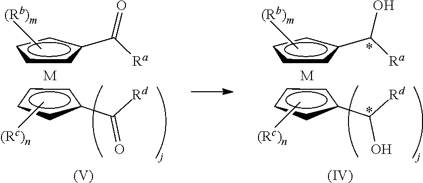
wherein:
the asymmetric transfer hydrogenation is carried out in an aqueous solvent at a temperature greater than 60° C. in the presence of an asymmetric transfer hydrogenation catalyst and activated formic acid;
wherein:
R^{a}, R^{b}, R^{c} and R^{d} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, substituted C₅-C₂₀-aryl, unsubstituted C₄-C₂₀-heteroaryl, and substituted C₄-C₂₀-heteroaryl, wherein the heteroatoms in the C₄-C₂₀-heteroaryl are selected from the group consisting of sulfur, oxygen and nitrogen;
R^{e} and R^{f} are independently selected from the group consisting of unsubstituted C₁-C₂₀-alkyl, substituted C₁-C₂₀-alkyl, unsubstituted C₃-C₁₅-cycloalkyl, substituted C₃-C₁₅-cycloalkyl, unsubstituted C₅-C₂₀-aryl, and substituted C₅-C₂₀-aryl;
M is selected from the group consisting of Fe, Ru, Os and Ni;
m is an integer from 0 to 4;
j is 0 or 1; and
when j=0, n is an integer from 0 to 5;
when j=1, n is an integer from 0 to 4; and
* denotes an optically active carbon atom.

44. The process according to claim 43, wherein R^{a} is methyl.

45. The process according to claim 43 wherein j is 0.

46. The process according to claim 43, wherein m is 0.

47. The process according to claim 43, wherein n is 0.

48. The process according to claim 43, wherein R^{a} is methyl and m, n and j are 0.

49. The process according to claim 43, wherein j is 1.

50. The process according to claim 43, wherein R^{d} is methyl.

51. The process according to claim 43, wherein R^{e} and R^{f} are methyl.

52. The process according to claim 43, wherein the asymmetric transfer hydrogenation catalyst is a complex of formula (VI): 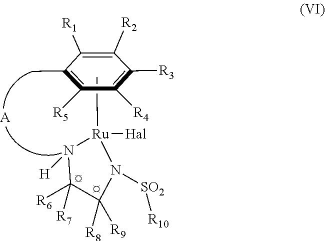
wherein,
R₁, R₂, R₃, R₄ and R₅ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, CN, —NR₂₀R₂₁, —COOH, COOR₂₀, —CONH₂, —CONR₂₀R₂₁ and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₃₀R₃₁, —COOR₃₀, —CONR₃₀R₃₁ and —CF₃; and/or
R₁ and R₂, R₂ and R₃, R₃ and R₄ or R₄ and R₅ together form an aromatic ring composed of 6 to 10 carbon atoms which is optionally substituted with one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃;
R₆, R₇, R₈ and R₉ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl and optionally substituted C₆₋₂₀ aryloxy, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃, or
R₆ and R₇ together with the carbon atom to which they are bound and/or R₅ and R₉ together with the carbon atom to which they are bound form an optionally substituted C₃₋₂₀ cycloalkyl or an optionally substituted C₃₋₂₀ cycloalkoxy, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃, or
one of R₆ and R₇ and one of R₅ and R₉ together form an optionally substituted C₅₋₁₀ cycloalkyl or an optionally substituted C₅₋₁₀ cycloalkoxy, wherein the substituents are independently selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀R₂₁, —COOR₂₀, —CONR₂₀R₂₁ and —CF₃,
provided R₆ and R₇ and/or R₅ and R₉ are not the same,
represents an optically active carbon atom;
R₁₀ is an optionally substituted straight C₁₋₁₀ alkyl, branched or cyclic C₃₋₁₀ alkyl, optionally substituted C₆₋₁₀ aryl or —NR₁₁R₁₂ wherein the substituents are selected from the group consisting of one or more straight C₁₋₁₀ alkyl, branched or cyclic C₃₋₁₀ alkyl, straight C₁₋₁₀ alkoxy, branched or cyclic C₃₋₁₀ alkoxy, C₆₋₁₀ aryl, C₆₋₁₀ aryloxy, -Hal, —OH, —CN, —NR₂₀R₂₁, —COOR₂₀, —CONR₂₀R₂₁ and —CF₃;
R₁₁ and R₁₂ are independently selected from the group consisting of hydrogen, optionally substituted straight C₁₋₁₀ alkyl, branched or cyclic C₃₋₁₀ alkyl and optionally substituted C₆₋₁₀ aryl, wherein the substituents are selected from the group consisting of one or more straight C₁₋₁₀ alkyl, branched or cyclic C₃₋₁₀ alkyl groups, straight C₁₋₁₀ alkoxy, branched or cyclic C₃₋₁₀ alkoxy, C₆₋₁₀ aryl, C₆₋₁₀ aryloxy, —OH, —CN, —NR₂₀R₂₁, —COOR₂₀, —CONR₂₀R₂₁ and —CF₃, or
R₁₁ and R₁₂ together with the nitrogen atom to which they are bound form an optionally substituted C₂₋₁₀ cycloalkyl-amino group, wherein the substituents are selected from the group consisting of one or more straight C₁₋₁₀ alkyl, branched or cyclic C₃₋₁₀ alkyl, straight C₁₋₁₀ alkoxy, branched or cyclic C₃₋₁₀ alkoxy, C₆₋₁₀ aryl, C₆₋₁₀ aryloxy, —OH, —CN, —NR₂₀R₂₁, —COOR₂₀, —CONR₂₀R₂₁ and —CF₃;
R₂₀ and R₂₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN, —NR₃₀R₃₁, —COOR₃₀, —CONR₃₀R₃₁ and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
R₃₀ and R₃₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
A is an optionally substituted straight- or branched-chain C₂₋₅ alkyl wherein the substituents are selected from the group consisting of one or more straight C₁₋₁₀ alkyl, branched or cyclic C₃₋₁₀ alkyl, straight C₃₋₁₀ alkoxy, branched or cyclic C₃₋₁₀ alkoxy, C₆₋₁₀ aryl and C₆₋₁₀ aryloxy, or
A is a group of formula (VII): 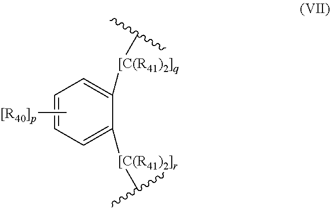
wherein p is an integer selected from 1, 2, 3 or 4;
each R₄₀ is independently selected from the group consisting of straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
q and r are independently integers selected from 0, 1, 2 or 3 wherein q+r=1, 2 or 3;
each R₄₁ is independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃; or
A is a group of formula (VIII): 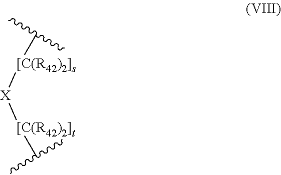
X is O or S;
s and t are independently integers selected from 0, 1, 2 or 3 wherein s+t=1, 2 or 3;
each R₄₂ is independently selected from the group consisting of hydrogen, straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃; and
Hal is a halogen.

53. The process according to claim 43, wherein the asymmetric transfer hydrogenation catalyst is a complex of formula (IX): 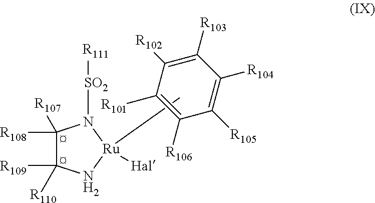
wherein,
R₁₀₁, R₁₀₂, R₁₀₃, R₁₀₄, R₁₀₅ and R₁₀₆ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, CN, —NR₂₀₀R₂₀₁, —COOH, COOR₂₀₀, —CONH₂, —CONR₂₀₀R₂₀₁ and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₃₀₀R₃₀₁, —COOR₃₀₀, —CONR₃₀₀R₃₀₁ and —CF₃; and/or
R₁₀₁ and R₁₀₂, R₁₀₂ and R₁₀₃, R₁₀₃ and R₁₀₄, R₁₀₄ and R₁₀₅ or R₁₀₅ and R₁₀₆ together form an aromatic ring composed of 6 to 10 carbon atoms which is optionally substituted with one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃;
R₁₀₇, R₁₀₈, R₁₀₉ and R₁₁₀ are each independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl and optionally substituted C₆₋₁₀ aryloxy, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃, or
R₁₀₇ and R₁₀₈ together with the carbon atom to which they are bound and/or R₁₀₉ and R₁₁₀ together with the carbon atom to which they are bound form an optionally substituted C₃₋₂₀ cycloalkyl or an optionally substituted C₂₋₂₀ cycloalkoxy, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃, or
one of R₁₀₇ and R₁₀₈ and one of R₁₀₉ and R₁₁₀ together form an optionally substituted C₅₋₁₀ cycloalkyl or an optionally substituted C₅₋₁₀ cycloalkoxy, wherein the substituents are independently selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN, —NR₂₀₀R₂₀₁, —COOR₂₀₀, —CONR₂₀₀R₂₀₁ and —CF₃,
provided R₁₀₁ and R₁₀₈ and/or R₁₁₀₉ and R₁₁₀ are not the same,
a represents an optically active carbon atom;
R₁₁₁ is an optionally substituted straight C₁₋₁₀ alkyl, branched or cyclic C₃₋₁₀ alkyl, optionally substituted C₆₋₁₀ aryl or —NR₁₁₂R₁₁₃, wherein the substituents are selected from the group consisting of one or more straight C₁₋₁₀ alkyl, branched or cyclic C₃₋₁₀ alkyl, straight C₁₋₁₀ alkoxy, branched or cyclic C₃₋₁₀ alkoxy, C₆₋₁₀ aryl, C₆₋₁₀ aryloxy, -Hal, —OH, —CN, —NR₂₀₀R₂₀₁, —COOR₂₀₀, —CONR₂₀₀R₂₀₁ and —CF₃;
R₁₁₂ and R₁₁₃ are independently selected from the group consisting of hydrogen, optionally substituted straight C₁₋₁₀ alkyl, branched or cyclic C₃₋₁₀ alkyl and optionally substituted C₆₋₁₀ aryl, wherein the substituents are selected from the group consisting of one or more straight C₁₋₁₀ alkyl, branched or cyclic C₃₋₁₀ alkyl groups, straight C₁₋₁₀ alkoxy, branched or cyclic C₃₋₁₀ alkoxy, C₆₋₁₀ aryl, C₆₋₁₀ aryloxy, —OH, —CN, —NR₂₀₀R₂₀₁, —COOR₂₀₀, —CONR₂₀₀R₂₀₁ and —CF₃, or
R₁₁₂ and R₁₁₃ together with the nitrogen atom to which they are bound form an optionally substituted C₂₋₁₀ cycloalkyl-amino group, wherein the substituents are selected from the group consisting of one or more straight C₁₋₁₀ alkyl, branched or cyclic C₃₋₁₀ alkyl, straight C₁₋₁₀ alkyl, branched or cyclic C₃₋₁₀ alkoxy, C₆₋₁₀ aryl, C₆₋₁₀ aryloxy, —OH, —CN, —NR₂₀₀R₂₀₁, —COOR₂₀₀, —CONR₂₀₀R₂₀₁ and —CF₃;
R₂₀₀ and R₂₀₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN, —NR₃₀R₃₁, —COOR₃₀₀, —CONR₃₀₀R₃₀₁ and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃;
R₃₀₀ and R₃₀₁ are independently selected from the group consisting of hydrogen, optionally substituted straight C₁₋₂₀ alkyl, branched or cyclic C₃₋₂₀ alkyl, optionally substituted straight C₁₋₂₀ alkoxy, branched or cyclic C₃₋₂₀ alkoxy, optionally substituted C₆₋₂₀ aryl, optionally substituted C₆₋₂₀ aryloxy, —OH, —CN and —CF₃, wherein the substituents are selected from the group consisting of one or more straight C₁₋₂₀ alkyl, branched or cyclic C₃₋₂₀ alkyl, straight C₁₋₂₀ alkoxy, branched or cyclic C₃₋₂₀ alkoxy, C₆₋₂₀ aryl, C₆₋₂₀ aryloxy, —OH, —CN and —CF₃; and
Hal′ is a halogen.

54. The process according to claim 43, wherein the aqueous solvent is water or a mixture of water and water-miscible solvents.

55. The process according to claim 43, wherein the asymmetric transfer hydrogen reaction is carried out at one or more temperatures in the range of ≥about 60° C. to about ≤about 100° C.

56. The process according to claim 43, wherein the activated formic acid is a mixture of formic acid, a tertiary amine base and optionally water.

57. The process according to claim 56, wherein the tertiary amine base is triethylamine.

58. The process according to claim 57, wherein the molar ratio of formic acid:tertiary amine is in the range of about 1:1 to about 1.2:1 moles.

59. The process according to claim 57, wherein the activated formic acid is a mixture of formic acid, a tertiary amine and water, and the concentration of formic acid:tertiary amine is in the range of 1 M:1 M to about 1.2 M:1 M.

60. The process according to claim 43, wherein the molar ratio of the metallocenyl compound of formula (V) to asymmetric transfer hydrogenation catalyst is in the range of about 100:1 to about 2000:1.

61. The process according to claim 60, wherein the molar ratio is ≥about 600:1.

62. The process according to claim 43, wherein M is Fe, and m is 0, 1, 2 or 3, and at least one of the carbon atoms ortho to the —R^{a}C*H(OH) group is unsubstituted, and further comprising transforming the metallocenyl alcohol of formula (IV) into a Bophoz or Josiphos ligand.

63. The process according to claim 14, wherein the enantiomeric excess of the compound of formula (II) is ≥97%.
